(19) United States
(12) Patent Application Publication
(10) Pub. No.: US 2013/0139729 A1
(43) Pub. Date: Jun. 6, 2013

(54) Providing Freeze-Thaw Durability to Cementitious Compositions

(71) Applicant: Construction Research & Technology GmbH, Trostberg (DE)

(72) Inventors: Frank Shaode Ong, Solon, OH (US); James Curtis Smith, Cuyahoga Hills, OH (US); Stefan Mussig, Sagamore Hills, OH (US); Harald Keller, Ludwigshafen (DE); Samy M. Shendy, Cuyahoga Falls, OH (US); Ashish Goel, Twinsburg, OH (US); Sandra R. Sprouts, Oakwood Village, OH (US)

(73) Assignee: Construction Research & Technology GmbH, Trosberg (DE)

(21) Appl. No.: 13/690,030

(22) Filed: Nov. 30, 2012

Related U.S. Application Data
(60) Provisional application No. 61/566,369, filed on Dec. 2, 2011.

(51) Int. Cl. C04B 16/00

(52) U.S. Cl. CPC C04B 16/00
USPC 106/697

(57) ABSTRACT

A cementitious freeze-thaw damage resistant composition includes hydraulic cement, and coffee grounds particles having a volume-weighted mean particle size of from greater than 50 μm to about 2000 μm. A method for preparing a freeze-thaw damage resistant cementitious composition includes forming a mixture of water, hydraulic cement, and coffee grounds particles having a volume-weighted mean particle size of from greater than 50 μm to about 2000 μm. The coffee grounds particles act to increase the freeze-thaw durability of the cementitious material. A cementitious freeze-thaw damage resistant composition comprising hydraulic cement, and organic particles comprising at least one of coffee grounds particles, leaf powder particles, starch microcontainers, ground tea leaf particles, or cork powder particles.

This application claims the benefit of the filing date under 35 U.S.C. §119(e) from United States Provisional Application For Patent Ser. No. 61/566,369 filed on Dec. 2, 2011, which is incorporated by reference herein.

It is well known that freezing and thawing cycles can be extremely damaging to water-saturated hardened cement compositions such as concrete. A known technique to prevent or reduce the damage done is the incorporation into the composition of microscopically fine air voids. The air voids are thought to function as internal expansion chambers to protect the concrete from freeze-thaw damage by relieving the hydraulic pressure caused by an advancing freezing front in the concrete. The method used in the industry for artificially producing such air voids in concrete has been by means of air-entraining agents, which stabilize tiny bubbles of air that are entrapped in the concrete during mixing.

These air voids are typically stabilized by use of surfactants during the mixing process of concrete. Unfortunately, this approach of entraining air voids in concrete is plagued by a number of production and placement issues, some of which are the following.

Air Content: Changes in air content of the cementitious mixture can result in concrete with poor resistance to freezing and thawing distress if the air content drops with time or reduces the compressive strength of concrete if the air content increases with time. Examples are pumping concrete (decrease air content by compression), job-site addition of a superplasticizer (often elevates air content or destabilizes the air void system), or interaction of specific admixtures with the air-entraining surfactant (could increase or decrease air content).

Air Void Stabilization: The inability to stabilize air bubbles can be due to the presence of materials that adsorb the stabilizing surfactant, i.e., fly ash with high surface area carbon or insufficient water for the surfactant to work properly, i.e, low slump concrete. Air entrainment in concrete containing fly ash is typically difficult to achieve, as air entraining admixture surfactant tends to adsorb to the fly ash surfaces, making it unavailable for air entrainment.

Air Void Characteristics: Formation of bubbles that are too large to provide resistance to freezing and thawing can be the result of poor quality or poorly graded aggregates, use of other admixtures that destabilize the bubbles, etc. Such voids are often unstable and tend to float to the surface of the fresh concrete.

Overfinishing: Removal of air by overfinishing, removes air from the surface of the concrete, typically resulting in distress by scaling of the detrained zone of cement paste adjacent to the overfinished surface.

The generation and stabilization of air at the time of mixing and ensuring it remains at the appropriate amount and air void size until the concrete hardens are day-to-day challenges for the ready mix concrete producer in North America.

Adequately air-entrained concrete remains one of the most difficult types of concrete to make. The air content and the characteristics of the air void system entrained into the concrete cannot be controlled by direct quantitative means, but only indirectly through the amount/type of air-entraining agent added to the mixture. Factors such as the composition and particle shape of the aggregates, the type and quantity of cement in the mix, the consistency of the concrete, the type of mixer used, the mixing time, and the temperature all influence the performance of the air-entraining agent. The void size distribution in ordinary air-entrained concrete can show a very wide range of variation, between 10 and 3,000 micrometers (μm) or more. In such concrete, besides the small voids which are essential to cyclic freeze-thaw resistance, the presence of larger voids—which contribute little to the durability of the concrete and could reduce the strength of the concrete—has to be accepted as an unavoidable feature.

ACI guidelines recommend that for acceptable performance and durability of concrete in a water-saturated cyclic freezing environment, the characteristics of an air void system in hardened concrete include an average void size (specific surface area) greater than 600 in⁻¹, and an average distance between the voids (spacing factor) equal to or less than 0.008 to ensure resistance to freezing and thawing cycles.

Those skilled in the art have learned to control for these influences by the application of appropriate rules for making air-entrained concrete. The exercise of particular care in making such concrete is required however, including continually checking the air content, because if the air content is too low, the freeze-thaw resistance of the concrete will be inadequate, and if the air content is too high, compressive strength is adversely affected.

Therefore, it is desirable to provide an admixture directly in a cementitious mixture that provides the cementitious composition with improved freeze-thaw durability.

A freeze-thaw damage resistant cementitious composition is provided which comprises hydraulic cement, and at least one of coffee grounds particles, leaf powder particles, starch microcontainers, ground tea leaf particles, or cork powder particles. The coffee grounds particles may be comminuted spent coffee grounds, having a volume-weighted (“v-w”) mean particle size of from greater than 50 μm to about 2000 μm. In certain embodiments, the coffee grounds particles have a volume-weighted mean particle size of greater than 50 μm to 1000 μm; in other embodiments about 100 μm to about 1000 μm. The leaf powder particles may comprise ground leaves, created by grinding leaves such as dead leaves collected during the Fall season. The ground tea leaf particles may comprise ground spent tea leaves.

Starch microcontainers comprise a physically modified corn starch which is modified to create porosity in the corn starch particles. In certain embodiments, the corn starch may be modified by an enzymatic process, such as in an aqueous slurry. During the enzymatic reaction, which may be catalyzed by amylase, the starch is partially hydrolyzed to soluble sugars and insoluble porous starch particles. The porous starch particles may be separated by filtration, washed to remove sugars, and/or dried. The resulting dry particles may be of similar size as unmodified starch particles, such as about 15 μm, and may have large inner voids and/or surface pores which may be connected to the inner voids. Starch microcontainers behave like containers in the sense that they can be filled with liquids. The starch microcontainers may be filled with liquids spontaneously, such as by capillary forces.

A method for preparing a freeze-thaw damage resistant cementitious composition is provided which comprises forming a mixture of water, hydraulic cement, and at least one of coffee grounds particles, leaf powder particles, starch microcontainers, ground tea leaf particles, or cork powder particles.

In certain embodiments, a method for preparing a freeze-thaw damage resistant cementitious composition is provided which comprises forming a mixture of water, hydraulic cement, and coffee grounds particles having a volume-weighted mean particle size of from greater than 50 μm to about 2000 μm.

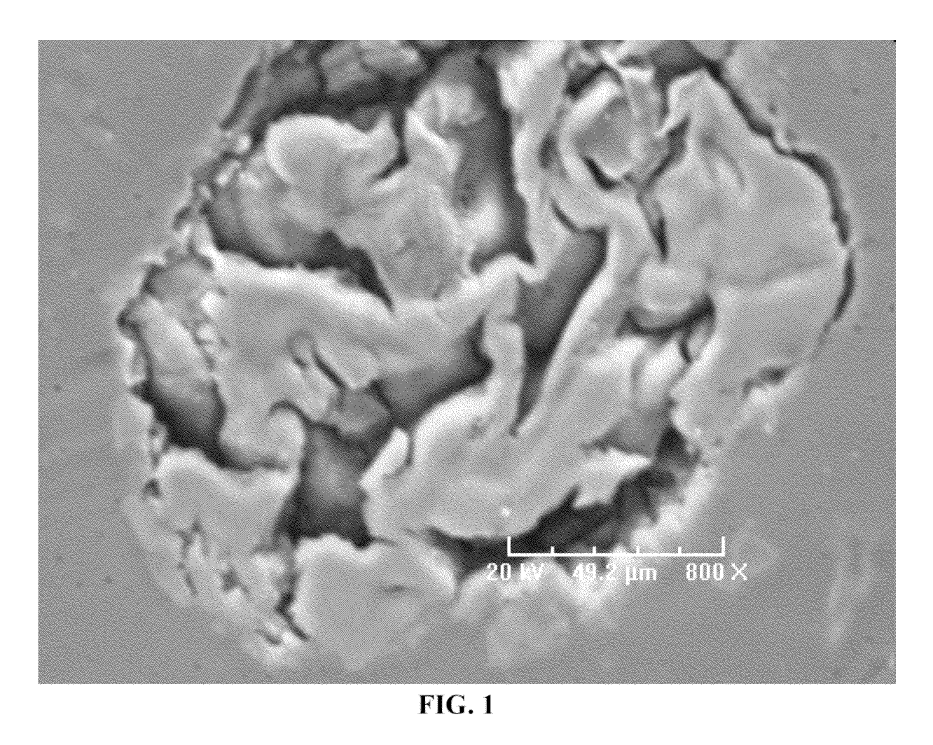

FIG. 1 is a photomicrograph of the microstructure of a comminuted spent coffee ground.

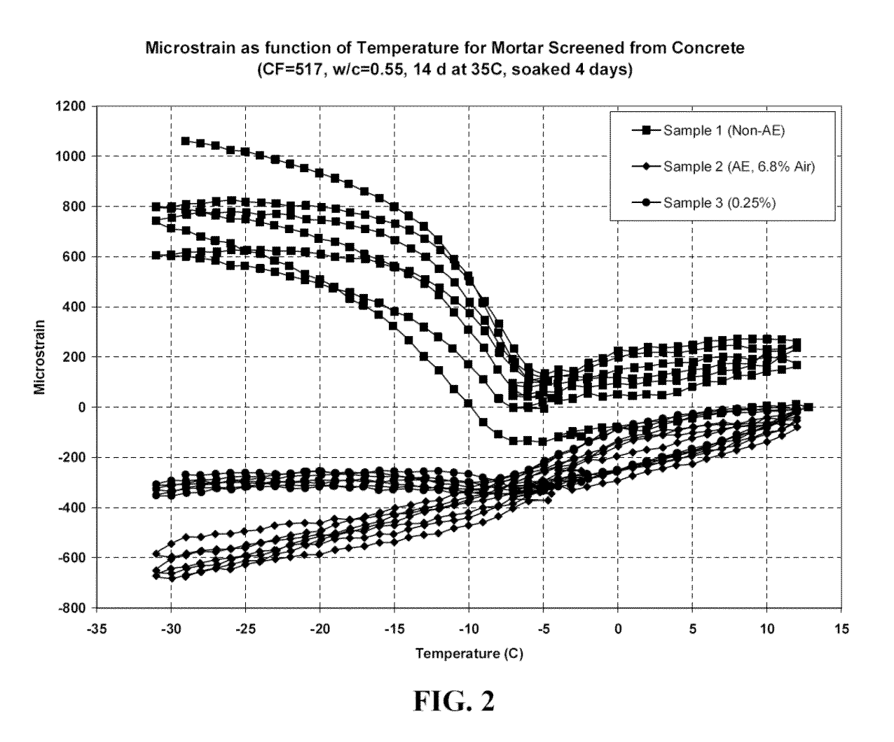

FIG. 2 is a graphical representation of cementitious composition freeze-thaw performance as measured by micro-strain due to specimen size changes across a temperature profile.

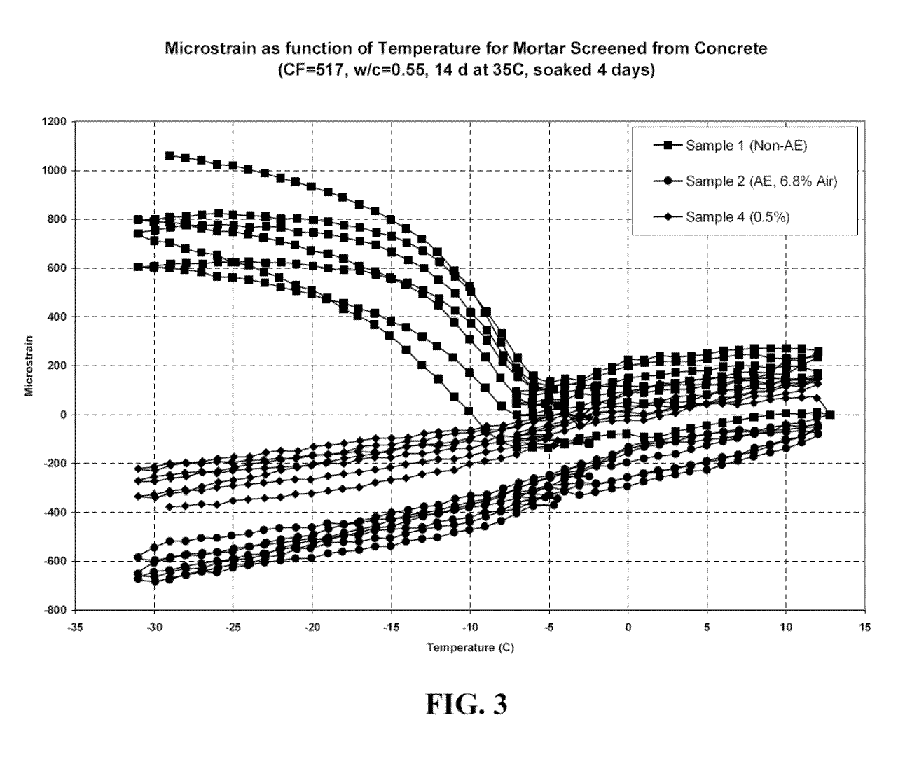

FIG. 3 is a graphical representation of cementitious composition freeze-thaw performance as measured by micro-strain due to specimen size changes across a temperature profile.

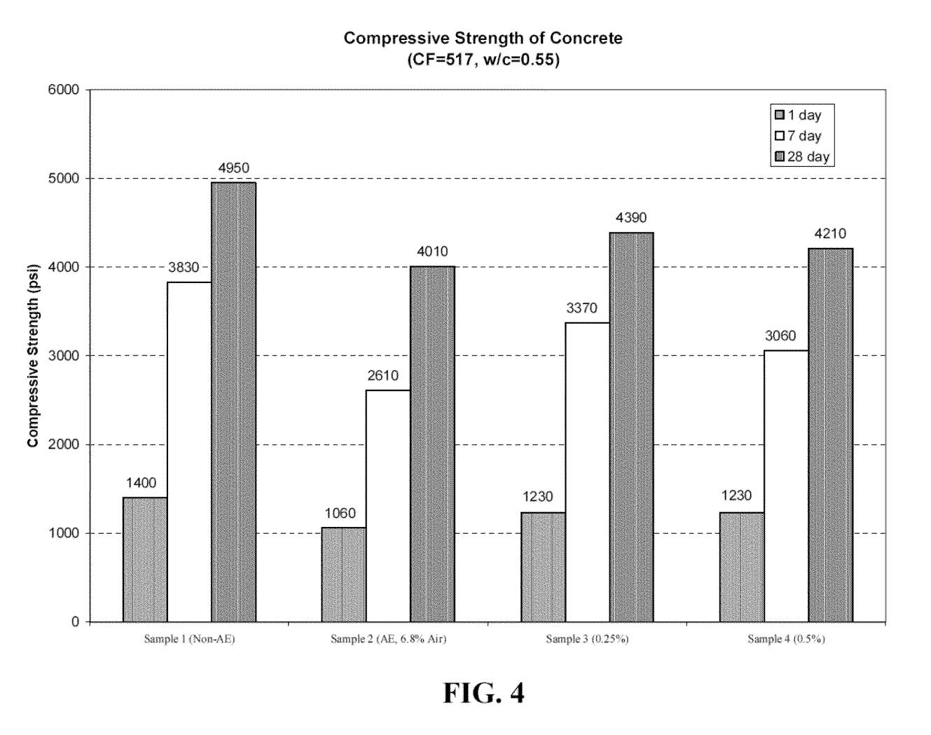

FIG. 4 is a bar graph comparing compressive strength for various cementitious compositions.

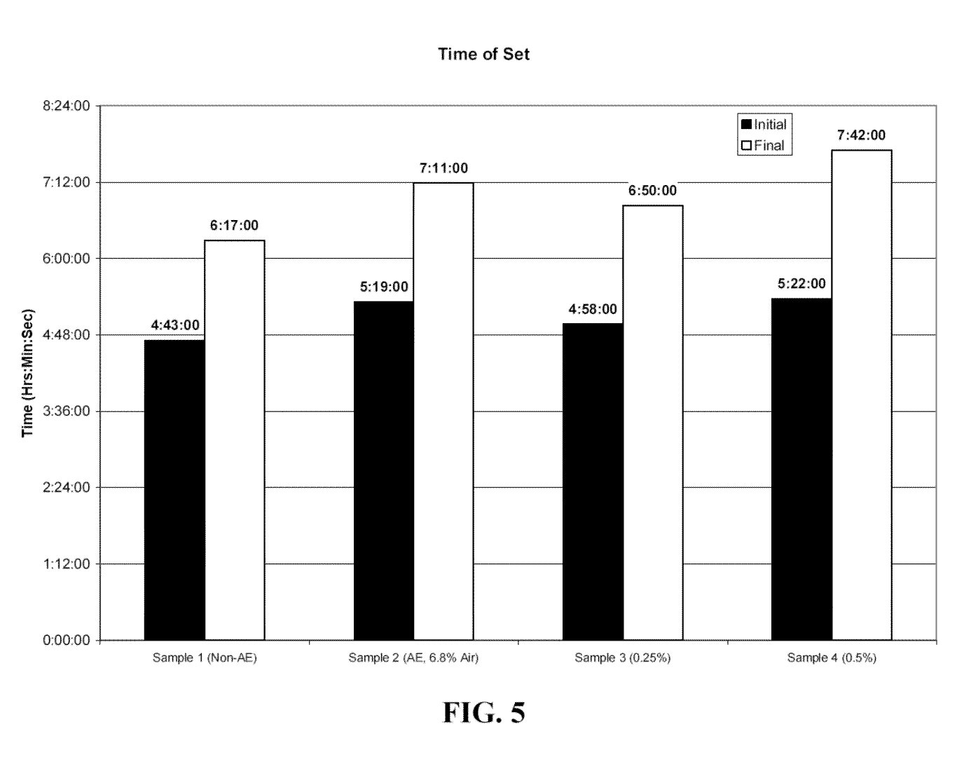

FIG. 5 is a bar graph comparing set times for various cementitious compositions.

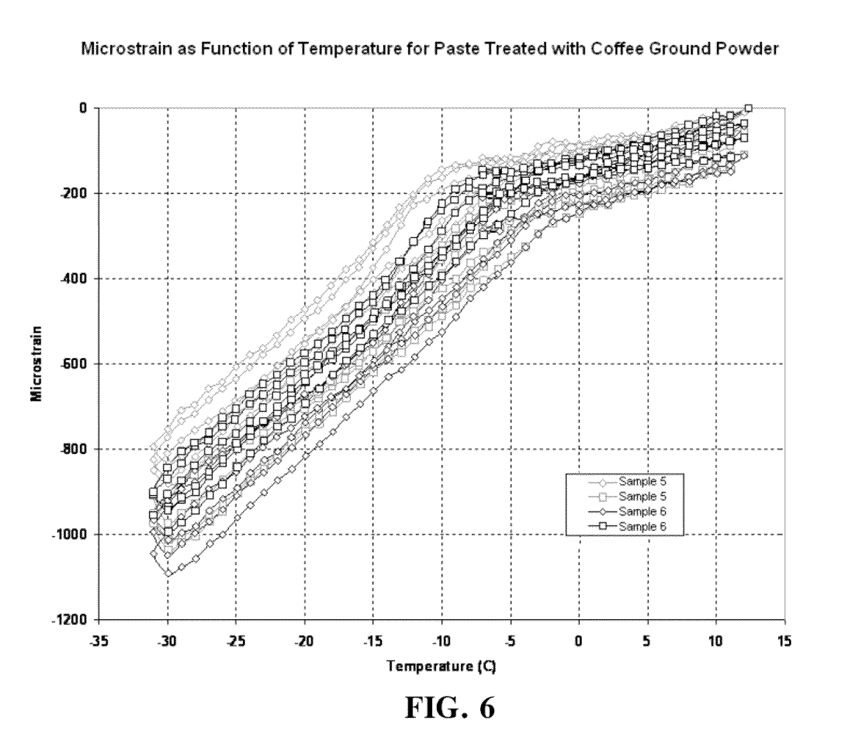

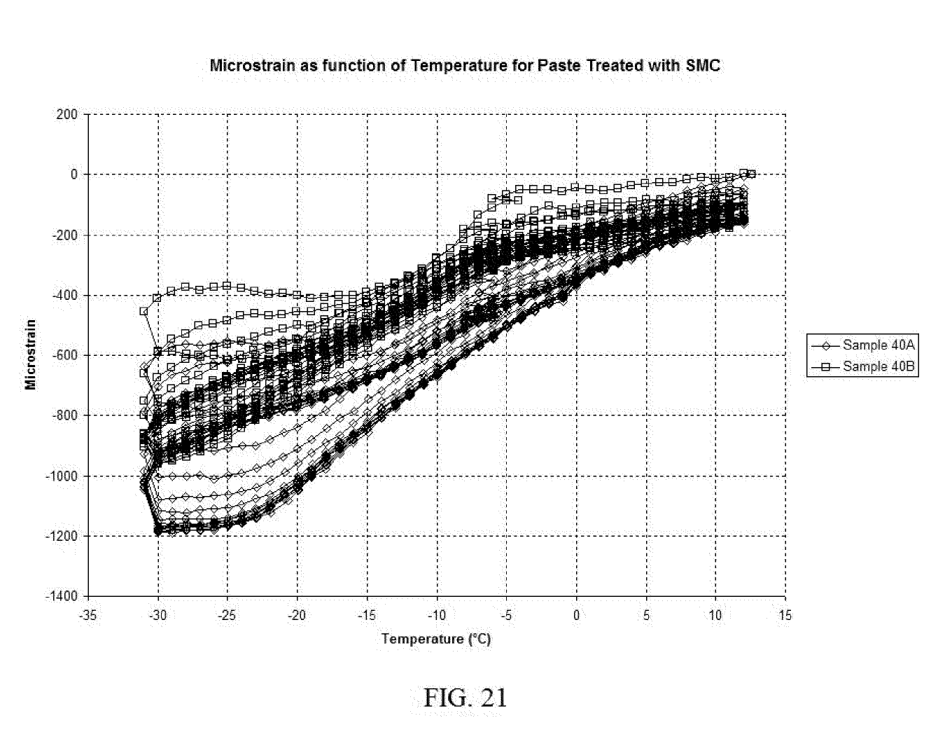

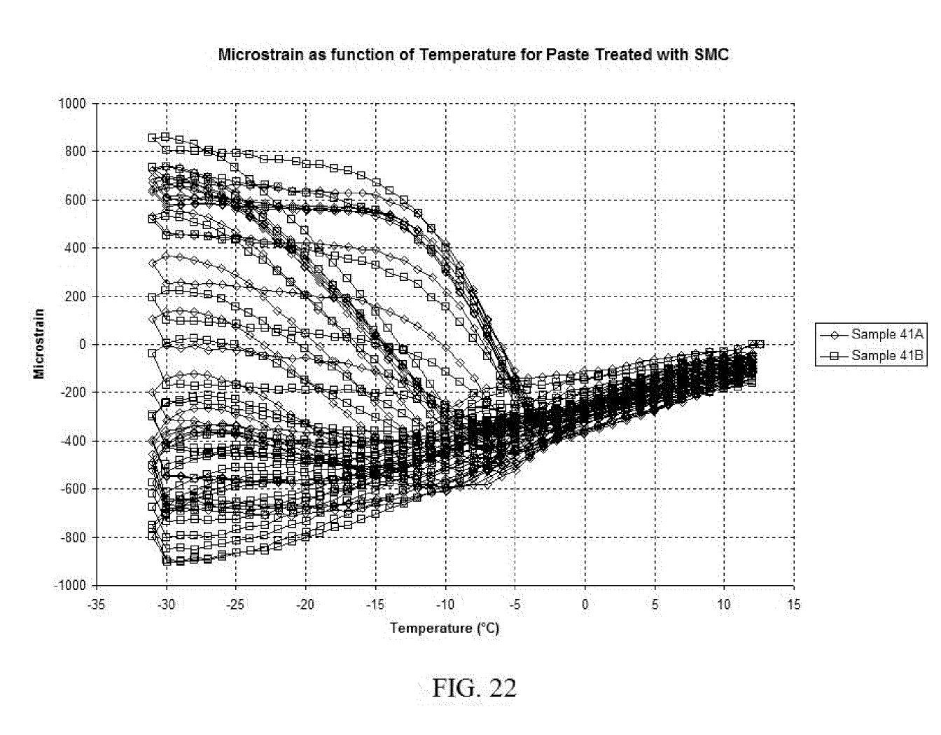

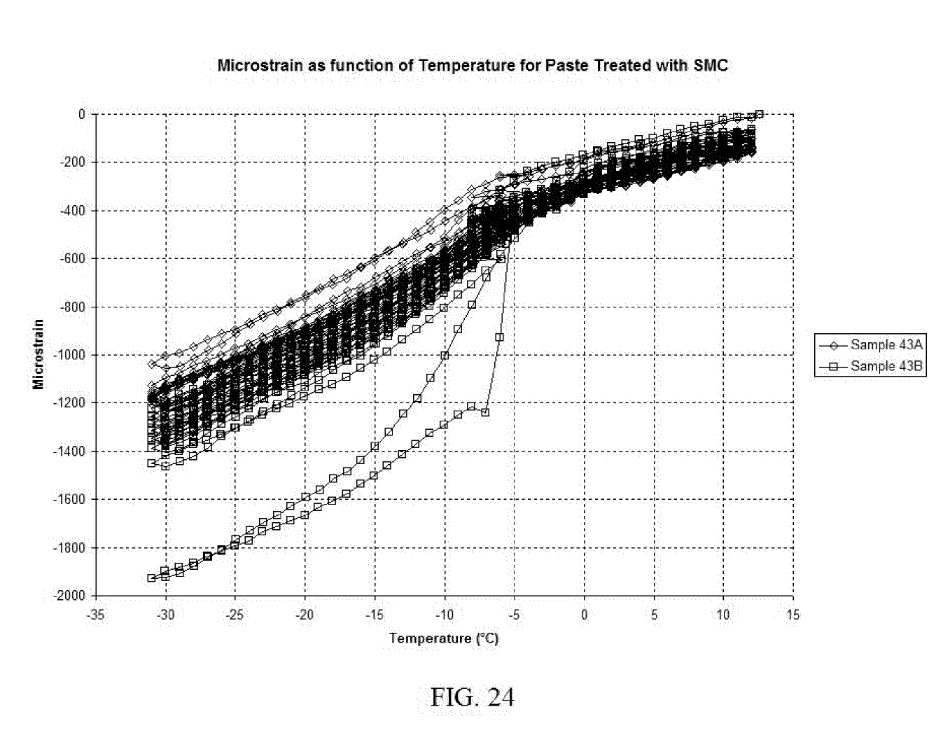

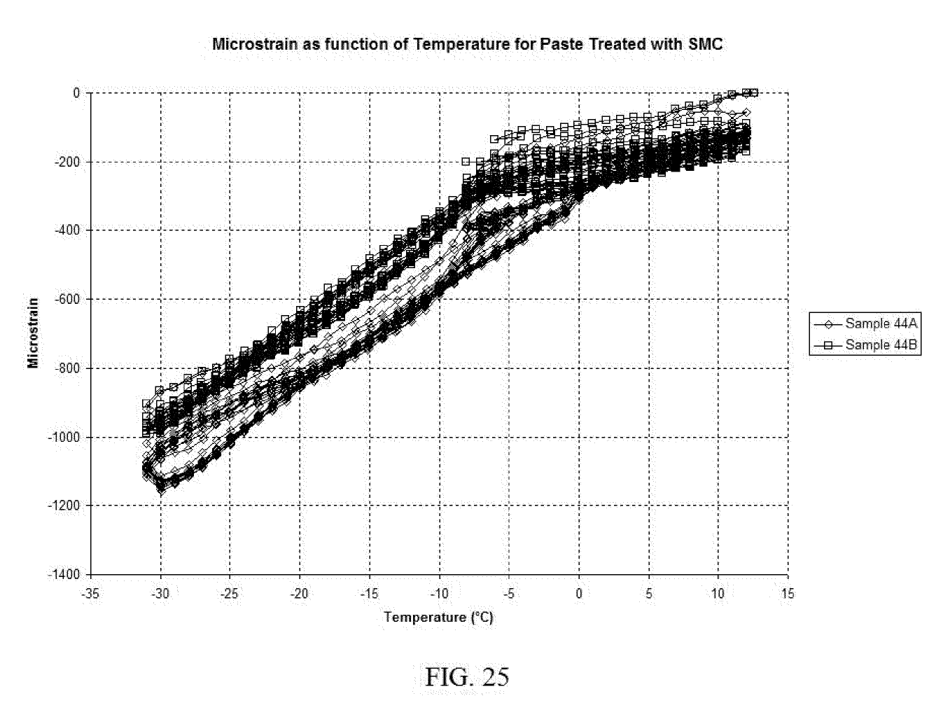

FIGS. 6 through 27 are graphical representations of cementitious composition freeze-thaw performance as measured by micro-strain due to specimen size changes across a temperature profile.

An improved freeze-thaw durability cementitious composition is provided. The freeze-thaw damage resistance of the cementitious composition is provided by the incorporation of at least one of small coffee grounds particles, leaf powder particles, starch microcontainers, ground tea leaf particles, or cork powder particles, having selected dimensions in the cementitious composition, such as concrete, grouts, mortars, and the like.

The use of at least one of coffee grounds particles, leaf powder particles, starch microcontainers, ground tea leaf particles, or cork powder particles, provides freeze-thaw durability to concrete and other cementitious compositions. The coffee grounds particles, leaf powder particles, starch microcontainers, ground tea leaf particles, or cork powder particles are referred to herein generally as particles or organic particles. These particles may be used in place of classical air entrainment methods to provide freeze-thaw durability to the cementitious composition.

Traditional air entrainment techniques are variable in their efficacy and polycarboxylates are known in the art for higher-than-desirable air contents. The disclosed particles allow for heavy use of defoaming agents to eliminate any adventitious air that might be brought about through variability in other raw materials in the concrete mix design.

The use of specifically sized particles may eliminate the problems in the industry involving freeze-thaw damage resistant concrete. It also makes possible the use of materials, i.e., low grade, high-carbon fly ash which are currently landfilled, as they are not usable in air-entrained cementitious compositions without further treatment. This results in cement savings, and therefore economic savings.

The cementitious composition and method of producing it use the subject organic particles to increase the freeze-thaw durability of the cementitious material without relying solely on air bubble stabilization during mixing of the cementitious composition.

Without intending to be limited by theory, it is believed that the freeze-thaw durability enhancement produced by the subject particles may involve a physical mechanism for relieving stresses produced when water freezes in a cementitious material. This is contrasted to conventional practice, in which particularly sized and spaced voids are generated in the hardened material by using air-entraining chemical admixtures to stabilize the air voids entrained during concrete mixing. It may be that small air voids exist in the subject particles which behave similarly in finished cementitious products to the voids stabilized by air-entraining chemical admixtures.

In the present cementitious composition and method, addition of the small-sized particles in the cementitious mixture at some time prior to final set results in freeze-thaw damage resistance or durability of the hardened concrete material.

In certain embodiments, the cementitious compositions provided may comprise hydraulic cement, and coffee grounds having a volume-weighted mean particle size of from greater than 50 μm to about 2000 μm. Water is added to form the cementitious composition into a paste. The cementitious composition may include mortars, grouts, shotcrete, concretes or any other composition which comprises cement. The applications for the disclosed cementitious compositions include flatwork, paving (which is typically difficult to air entrain by conventional means), vertical applications, precast poured cement compositions and articles formed from cementitious compositions.

The cementitious composition in which the present admixture is used will generally be exposed to the environment; that is, the cementitious composition will be in an environment exposed to weathering, and freeze-thaw cycling.

The hydraulic cement can be a portland cement, a calcium aluminate cement, a magnesium phosphate cement, a magnesium potassium phosphate cement, a calcium sulfoaluminate cement or any other suitable hydraulic binder. Aggregate may be included in the cementitious composition. The aggregate, by way of example but not limitation, may include silica, quartz, sand, crushed marble, glass spheres, granite, limestone, calcite, feldspar, alluvial sands, any other durable aggregate, and mixtures thereof.

The coffee grounds particles, by way of example but not limitation, may be formed by crushing, grinding or milling coffee beans, coffee grounds, and/or spent coffee grounds. Sources of spent coffee grounds include coffee grounds that have been utilized in the commercial production of instant coffee powder or freeze-dried coffee granules. Spent coffee grounds used in brewing coffee for other purposes, may be used as well. By means of example and not limitation, the coffee grounds particles may be created by pulverizing coffee beans, coffee grounds and/or spent coffee grounds using comminution equipment such as high shear mixers in a water slurry, commercial pin mills, and the like.

The coffee grounds particles may have a volume-weighted mean diameter of from greater than 50 μm to about 2000 μm, and in certain embodiments may have a volume-weighted mean diameter of greater than 50 μm to about 1000 μm. In some embodiments, the coffee grounds particles may have a volume-weighted mean diameter of from about 100 μm to about 1000 μm. Particle size may be measured by conventional means, such as, but not limited to a Mastersizer 2000 particle size analyzer, available from Malvern Instruments, Inc., Westborough, Mass. The coffee grounds particles may have a density of about 0.6 to about 1.5 g/cm³. The other subject organic particles may have similar sizes and densities.

The smaller the diameter of the coffee grounds particles, the lower the volume of material that is required to provide the desired freeze-thaw damage resistance to the cementitious composition. This is beneficial from a performance perspective, in that less of a decrease in compressive strength occurs by their addition, as well as an economic perspective, since a lower mass of particles is required.

The amount of coffee grounds particles to be added to the cementitious composition is about 0.2 percent to 7 percent of the total volume of the cementitious composition, in certain embodiments about 0.25 percent to about 3 percent of total volume, and in other embodiments about 0.25 percent to about 2 percent of total volume. In certain embodiments, the coffee grounds particles may be added to the cementitious composition in amounts of from about 0.5 percent by weight to about 12 percent by weight based on the weight of dry cement, in some embodiments, about 0.65 percent by weight to about 5.6 percent by weight based on the weight of dry cement.

The subject organic particles may be added to cementitious compositions in a number of forms. The first is as a dry powder, in which dry powder handling equipment for use with very low bulk density material can be used. The particles may be provided as a damp powder or a slurry. In certain embodiments, use of a liquid admixture such as a viscosity modifying admixture, paste or slurry substantially reduces the loss of material during the charging of the mixer. A third form is as a compact mass, such as a block or puck, similar to the DELVO® ESC admixture sold by BASF Admixtures, Cleveland, Ohio. The particles may be preformed into discreet units with an adhesive that breaks down in water.

The particles may be added as a powder to a cementitious mixture with the cement and other dry ingredients, as a slurry with other liquid admixtures or process water, in various forms into the cementitious mixture during mixing of the ingredients with water at a ready mix plant or on site, or in any other convenient manner during the preparation and/or placing of the cementitious composition.

The cementitious composition described herein may contain other additives or ingredients and should not be limited to the stated formulations. Cement additives that can be added independently include, but are not limited to: air entrainers, aggregates, pozzolans, dispersants, set and strength accelerators/enhancers, set retarders, water reducers, corrosion inhibitors, wetting agents, water soluble polymers, water repellents, fibers, dampproofing admixtures, permeability reducers, pumping aids, fungicidal admixtures, germicidal admixtures, insecticide admixtures, finely divided mineral admixtures, alkali-reactivity reducer, bonding admixtures, shrinkage reducing admixtures, and any other admixture or additive that does not adversely affect the properties of the cementitious composition. The cementitious compositions need not contain one of each of the foregoing additives.

Aggregate can be included in the cementitious formulation to provide for mortars which include fine aggregate, and concretes which also include coarse aggregate. The fine aggregate are materials that almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed marble, glass spheres, granite, limestone, calcite, feldspar, alluvial sands, sands or any other durable aggregate, and mixtures thereof.

A pozzolan is a siliceous or aluminosiliceous material that possesses little or no cementitious value but will, in the presence of water and in finely divided form, chemically react with the calcium hydroxide produced during the hydration of portland cement to form materials with cementitious properties. Diatomaceous earth, opaline cherts, clays, shales, fly ash, slag, silica fume, volcanic tuffs and pumicites are some of the known pozzolans. Certain ground granulated blast-furnace slags and high calcium fly ashes possess both pozzolanic and cementitious properties. Natural pozzolan is a term of art used to define the pozzolans that occur in nature, such as volcanic tuffs, pumices, trasses, diatomaceous earths, opaline, cherts, and some shales. Nominally inert materials can also include finely divided raw quartz, dolomites, limestones, marble, granite, and others. Fly ash is defined in ASTM C618.

If used, silica fume can be uncompacted or can be partially compacted or added as a slurry. Silica fume additionally reacts with the hydration byproducts of the cement binder, which provides for increased strength of the finished articles and decreases the permeability of the finished articles. The silica fume, or other pozzolans such as fly ash or calcined clay such as metakaolin, can be added to the cementitious mixture in an amount from about 5% to about 70% based on the weight of cementitious material.

A dispersant if used in the cementitious composition can be any suitable dispersant such as lignosulfonates, beta naphthalene sulfonates, sulfonated melamine formaldehyde condensates, polyaspartates, polycarboxylates with and without polyether units, naphthalene sulfonate formaldehyde condensate resins, or oligomeric dispersants. The term dispersant is also meant to include those chemicals that also function as a plasticizer, high range water reducer, fluidizer, antiflocculating agent, or superplasticizer for cementitious compositions.

Polycarboxylate or polycarboxylate ether dispersants can be used, by which is meant a dispersant having a carbon backbone with pendant side chains, wherein at least a portion of the side chains are attached to the backbone through a carboxyl, ether, amide or imide group. Polycarboxylate dispersants typically include cement particle bonding moieties, such as but not limited to carboxylic acid groups, and dispersing side chains that include polyoxyalkylene ethers, and may include other functional moieties.

The term oligomeric dispersant refers to oligomers that are a reaction product of: component A, optionally component B, and component C; wherein each component A is independently a nondegradable, functional moiety that adsorbs onto a cementitious particle; wherein component B is an optional moiety, where if present, each component B is independently a nondegradable moiety that is disposed between the component A moiety and the component C moiety; and wherein component C is at least one moiety that is a linear or branched water soluble, nonionic polymer substantially non-adsorbing to cement particles.

Set and strength accelerators/enhancers may accelerate the rate of cement hydration and provide early set and/or early strength development in cementitious compositions.

Set retarding, also known as delayed-setting or hydration control, admixtures are used to retard, delay, or slow the rate of setting of cementitious compositions. They can be added to the cementitious composition upon initial batching or sometime after the hydration process has begun. Set retarders are used to offset the accelerating effect of hot weather on the setting of cementitious compositions, or delay the initial set of cementitious compositions when difficult conditions of placement occur, or problems of delivery to the job site, or to allow time for special finishing processes. Most set retarders also act as low level water reducers and can also be used to entrain some air into cementitious compositions.

Corrosion inhibitors in cementitious compositions serve to protect embedded reinforcing steel from corrosion. The high alkaline nature of cementitious compositions causes a passive and non-corroding protective oxide film to form on the steel. However, carbonation or the presence of chloride ions from deicers or seawater, together with oxygen can destroy or penetrate the film and result in corrosion. Corrosion-inhibiting admixtures chemically slow this corrosion reaction.

In the construction field, many methods of protecting cementitious compositions from tensile stresses and subsequent cracking have been developed through the years. One modern method involves distributing fibers throughout a fresh cementitious mixture. Upon hardening, this cementitious composition is referred to as fiber-reinforced cement.

Dampproofing admixtures reduce the permeability of concrete that has low cement contents, high water-cement ratios, or a deficiency of fines in the aggregate portion. These admixtures retard moisture penetration into wet concrete. Permeability reducers are used to reduce the rate at which water under pressure is transmitted through cementitious compositions.

Pumping aids are added to cement mixes to improve pumpability. These admixtures thicken the fluid cementitious compositions, i.e., increase its viscosity, to reduce de-watering of the paste while it is under pressure from the pump.

Bacteria and fungal growth on or in hardened cementitious compositions may be partially controlled through the use of fungicidal, germicidal, and insecticidal admixtures.

Coloring admixtures are usually composed of pigments, either organic pigments or inorganic pigments such as metal-containing pigments that comprise, but are not limited to metal oxides and others.

Alkali-reactivity reducers can reduce the alkali-aggregate reaction and limit the disruptive expansion forces that this reaction can produce in hardened cementitious compositions.

The shrinkage reducing agents decrease shrinkage of cementitious compositions such as concrete and mortar upon drying.

In one embodiment the freeze-thaw damage resistant cementitious composition comprises hydraulic cement, water, and coffee grounds particles having a volume-weighted mean particle size of from greater than 50 μm about 2000 μm. In certain embodiments the spent coffee grounds particles may have a volume-weighted mean diameter of from greater than 50 μm to about 1000 μm.

In another embodiment the cementitious compositions described above further comprise independently at least one of the following: dispersants, air entrainers, set and strength accelerators/enhancers, set retarders, water reducers, aggregate, corrosion inhibitors, wetting agents, water soluble polymers, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures, or mixtures thereof.

In another embodiment a method for preparing a freeze-thaw damage resistant cementitious composition is provided that comprises providing a mixture of hydraulic cement, water, and coffee grounds particles having a volume-weighted mean particle size of from greater than 50 μm to about 2000 μm. In certain embodiments the comminuted spent coffee grounds particles are added as a compact mass, powder, or liquid admixture such as a viscosity modifying admixture, paste or slurry.

Experiments with comminuted spent coffee grounds, mixed into the cementitious composition prior to setting, provided cementitious compositions which successfully passed freeze/thaw durability testing. The freeze-thaw characteristics of the comminuted, spent coffee grounds containing cementitious material samples were compared to the freeze-thaw characteristics of air entrained and non-air entrained cementitious material samples, as reported below.

Cementitious compositions were prepared by mixing the components listed in Table 1, below. The non-air entrained Sample 1 contained no air entraining or freeze-thaw durability additive, the air entrained Sample 2 contained a commercial air entraining admixture but no other freeze-thaw durability admixture, and the remaining Samples 3 and 4 contained comminuted spent coffee grounds, but no air entraining admixture. The cementitious samples had a cement factor of 517, and a water to cement ratio of 0.55. The particle size of the comminuted spent coffee grounds averaged about 130 μm as measured by a Malvern Instruments Mastersizer 2000 unit, with 80% of the particles having a particle size between 30 and 545 μm, and a surface weighted mean of about 70 μm and a volume weighted mean of 215 μm.

TABLE 1

| | Sample No. | | | |
|---|---|---|---|---|
| | 1 | 2 | 3 | 4 |
| Admixture 1 | | AE-90 | C.G. | C.G. |
| Dose (oz/cwt) | | 1.35 | | |
| Dose (ml) | | 11.5 | | |
| Admixture 2 | | | TBP | TBP |
| Dose (oz/cwt) | | | 0.01 | 0.01 |
| Dose (grams) | | | 37 | 37 |
| Coffee Grounds (grams/28.7 lbs) | | | 152.4 | 304.8 |
| Cement (lbs) | 28.7 | 28.7 | 28.7 | 28.7 |
| Total Cementitious (lbs/yd3) | 28.7 | 28.7 | 28.7 | 28.7 |
| Sand (lbs) | 76.4 | 71.6 | 76.4 | 76.4 |
| Total Stone (lbs) | 104.7 | 98.1 | 104.7 | 104.7 |
| Stone 1 (lbs) | 62.6 | 58.7 | 62.6 | 62.6 |
| Stone 2 (lbs) | 42.1 | 39.4 | 42.1 | 42.1 |
| Water (lbs) | 15.8 | 15.8 | 15.8 | 15.8 |
| Water/Cement | 0.55 | 0.55 | 0.55 | 0.55 |
| Sand/Aggregate Ratio | 0.44 | 0.44 | 0.44 | 0.44 |
| Air Content (%) | | | | |
| 5 Min | 1.3 | 7.2 | 8.5 | 11.0 |
| 7 Min | — | — | 2.5 | 1.9 |

TBP = Tributyl Phosphate (Defoamer)
C.G. = Comminuted Coffee Grounds

### Freeze-Thaw Durability

The samples were obtained by screening a cementitious paste from the compositions to remove aggregate. The screened samples were held at 35° C. for 14 days, and were soaked in water for 4 days prior to conducting freeze-thaw testing.

### Test Procedure

The freeze-thaw durability of Samples 1-4 were tested according to a methodology developed by BASF Admixture Systems of Beachwood, Ohio. The BASF micro-strain freeze-thaw test method results exhibit excellent correlation to the industry accepted ASTM Standard C666 test results, while requiring only a fraction of the cementitious material for testing and providing results in days rather than months.

The BASF micro-strain freeze-thaw test method for predictive freeze-thaw durability performance utilizes real-time data collection and analysis of multiple samples simultaneously through the use of micro-strain measurement during at least one cooling (i.e. freezing) and optionally one warming or thawing temperature cycle, typically for multiple cycles. The temperature profile of the BASF freeze-thaw test method in one embodiment reduces the temperature of a test chamber housing cementitious specimens from a chamber temperature of about 10° C. to about minus 31° C. at a rate of 0.5° C. per minute, holds at the lowest temperature achieved for 30 minutes, and then increases the temperature of the chamber at a rate of 0.5° C. per minute, holding at the highest temperature achieved for 30 minutes, and then repeats the cycle.

Specimens within the test chamber are fitted with strain gauge sensors capable of detecting micro-strain differentials based on the changes in a dimension of the specimen due to shrinkage and/or expansion of the specimen as a function of temperature. Such sensors are available from Vishay Americas, Inc., of Shelton Conn.

The test method captures individual micro-strain data points at varying time intervals as desired, as well as calculates average micro-strain at 1° C. increments. This predictive durability test also provides insight into the mechanisms of resistance and/or failure during freeze-thaw distress. A real-time display allows the operator to see the precise point of water-to-ice transition and its effect on shrinkage or expansion of the individual test specimens.

Test samples for this method were produced using 800 gram paste batches at a 0.55 water-to-cement ratio. This method also works with mortars and screened concrete specimens, in which the aggregate is removed prior to testing of the residual paste or mortar. Materials were placed into 10 mL syringes under light vibration to eliminate large air pockets and “bug holes” internally and on the outer surfaces. Each resultant specimen was cylindrical with a diameter of approximately 1.5 cm and a length of about 6 cm, weighing approximately 15-25 g depending on constituent materials.

Test samples may be moist-cured at 32° C. (90° F.) for fourteen (14) days prior to testing. The remaining processes are conducted at ambient lab/test chamber conditions. Individual micro-strain gauges are attached to each test specimen and all specimens may be pre-soaked in sealed centrifuge tubes with distilled water for 18-24 hours prior to testing. At the conclusion of the pre-soak period, free water is drained from the sample tubes and then resealed to prevent moisture loss in the specimens during cycling.

Specimens may then be equilibrated in the test chamber to 10° C. (50° F.) before starting the temperature cycle profile and data collection. In certain embodiments, the test may be conducted in air at 100% humidity. Predictive performance can be acquired within 6-9 hours from the start of data collection.

Pass-fail characteristics of test specimens will be explained with respect to Samples 1 through 4 and FIGS. 2 and 3. As the specimens were cooled from about 10° C., the micro-strain sensors indicated that the cementitious material specimens began to contract linearly at a rate corresponding approximately to the coefficient of thermal expansion for concrete. At approximately negative 5° C., ice began to form in the specimens, and the temperature rebounded slightly due to heat of crystallization.

In the non-air entrained Sample 1 specimen having an air content of 2.5% by volume, when further cooling commenced, the micro-strain sensors indicated that the non-air entrained specimen began to expand as the temperature of the specimen decreased. It is theorized that the expansion of the non-air entrained specimens is caused by expansion of water crystallizing to ice in micropores in the cementitious material, and to structural damage caused by the expansion of water.

As the temperature cycled to the warming mode, the micro-strain sensors indicated that the non-air entrained specimen began to shrink, theoretically as ice within the pores began to melt, until all of the ice had melted at about negative 5° C. The specimen then began to expand linearly according to the thermal coefficient of cementitious material as it returned to 10° C. In subsequent cycles, the same pattern repeated, except that the expansion of the specimen was more pronounced during cooling below negative 5° C., perhaps indicating that the structural damage to the specimen was cumulative.

In the entrained air Sample 2 specimen, having an air content of 6.8% by volume, after the linear contraction of the specimen to about negative 5° C., the specimen continued to contract at a rate corresponding to a composite coefficient of thermal expansion of the cementitious material and ice contained within its pores. When warming of the specimen commenced and proceeded, the air-entrained specimen expanded linearly, substantially at the same rates as it had contracted. The behavior of the air entrained specimen in subsequent cycles followed the same cooling contraction and warming expansion characteristics as in the first cycle, indicating that the specimen remained structurally identical through multiple freeze-thaw cycles.

When the Sample 3 specimen, containing 0.25% by volume comminuted spent coffee grounds based on the total volume of the specimen, was subjected to the cooling cycle, it also exhibited linear contraction to about negative 5° C. as did specimens of Samples 1 and 2, as shown in FIG. 2. Below negative 5° C., the micro-strain sensors indicated that the specimen contracted slightly. The Sample 3 specimen followed the same reverse rate of expansion during the warming cycle. The comminuted spent coffee grounds containing specimen of Sample 3 exhibited similar contraction and expansion characteristics in subsequent freeze-thaw cycles.

When the Sample 4 specimen, containing 0.5% by volume comminuted spent coffee grounds based on the total volume of the specimen, was subjected to the cooling cycle, it also exhibited linear contraction to about negative 5° C. as did specimens of Samples 1 and 2, as shown in FIG. 3. Below negative 5° C., the micro-strain sensors indicated that the Sample 4 specimen continued to contract, following the same reverse rate of expansion during the warming cycle. The comminuted spent coffee grounds containing Sample 4 specimen exhibited similar contraction and expansion characteristics in subsequent freeze-thaw cycles.

Correlation studies of the BASF freeze-thaw test method with the existing ASTM C666 methodology have been conducted successfully. Test materials of varying air-quality and strength were tested in both the ASTM C666 and the predictive micro-strain methodology. The predictive results of the micro-strain method mirrored the actual results of the more cumbersome and time-consuming ASTM C666 method. Test samples for the ASTM C666 method can weigh between 15-25 pounds, the testing can take at least three months to complete, and the data collected offers no insight into the mechanism of resistance and/or failure for any test specimen.

### Compressive Strength

Tests were conducted on specimens made from the cementitious composition batches of Samples 1 through 4 to determine the effect of the addition of comminuted spent coffee grounds particles to the cementitious compositions on compressive strength according to standard test procedures. Results of the compressive strength tests (in psi) are shown in Table 2 and FIG. 4.

TABLE 2

| | Sample No. | | | |
|---|---|---|---|---|
| | 1 | 2 | 3 | 4 |
| | (Non-AE) | (AE-90, 6.8% Air) | (0.25% Vol.) | (0.5% Vol.) |
| 1 day | 1400 | 1060 | 1230 | 1230 |
| 7 day | 3830 | 2610 | 3370 | 3060 |
| 28 day | 4950 | 4010 | 4390 | 4210 |

The compressive strength of the freeze-thaw resistant Samples 3 and 4 specimens containing the comminuted spent coffee grounds particles exceeded the compressive strength of the freeze-thaw resistant air entrained Sample 2 specimen at 1 day, 7 days and 28 days.

### Set Time

Tests were conducted on specimens made from the cementitious composition batches of Samples 1 through 4 to determine the effect of the addition of comminuted spent coffee grounds particles to the cementitious compositions on set times according to standard test procedures. Results of the set time tests (in hrs:min:sec) are shown in Table 3 and FIG. 5.

TABLE 3

| | Sample No. | | | |
|---|---|---|---|---|
| | 1 | 2 | 3 | 4 |
| | (Non-AE) | (AE-90, 6.8% Air) | (0.25% Vol.) | (0.5% Vol.) |
| Initial | 4:43:00 | 5:19:00 | 4:58:00 | 5:22:00 |
| Final | 6:17:00 | 7:11:00 | 6:50:00 | 7:42:00 |

For lower loadings of comminuted spent coffee grounds as in the Sample 3 specimen, the set times were faster than set times for the air entrained Sample 2 specimen and about on the same order as the non-air entrained Sample 1 specimens. For higher loadings of comminuted spent coffee grounds as in the Sample 4 specimen, the set times were about on the same order as the set times for the air entrained Sample 2 specimen. There is no disadvantage with respect to set times for the use of comminuted spent coffee grounds in cementitious compositions for freeze-thaw resistance, as compared to conventional air entrained cementitious compositions.

Additional specimens of cementitious paste compositions containing spent coffee grounds comminuted by various methods, and added at various loading levels, were prepared according to the mix designs set forth in Table 4 and were tested for freeze-thaw resistance as reported below.

TABLE 4

| | | | Coffee | | Ratio of | Ratio of | Weight of | Plastic | |
|---|---|---|---|---|---|---|---|---|---|
| | | | Grounds | | C.G. to | C.G. to total | 400 mL of | (Entrained) | Mean Particle |
| Sample | CEMENT | WATER | Powder | W/C | cement | mixture | mixture | Air | Size μm |
| No. | (Grams) | (Grams) | (Grams) | (Wt. ratio) | (Wt. ratio) | (Vol. ratio) | (g) | (Volume %) | volume-weighted |
| 5 | 800.0 | 440.00 | 10.00 | 0.55 | 0.0125 | 0.01 | 706.9 | 0.9 | N/D |
| 6 | 800.0 | 440.00 | 20.00 | 0.55 | 0.0250 | 0.02 | 704.6 | 1.1 | N/D |
| | | | Pin-mill | | | | | | |
| 7 | 800.0 | 440.00 | 20.79 | 0.55 | 0.0260 | 0.05 | 694.7 | 2.5 | 473 |
| 8 | 800.0 | 440.00 | 10.40 | 0.55 | 0.0130 | 0.025 | 695.4 | 2.5 | 473 |
| 9 | 800.0 | 440.00 | 7.80 | 0.55 | 0.0097 | 0.019 | 701.2 | 1.8 | 473 |
| 10 | 800.0 | 440.00 | 5.20 | 0.55 | 0.0065 | 0.012 | 702.5 | 1.6 | 473 |
| | | | Blender | | | | | | |
| 11 | 800.0 | 440.00 | 20.79 | 0.55 | 0.0260 | 0.05 | 697.3 | 2.1 | 236 |
| 12 | 800.0 | 440.00 | 10.40 | 0.55 | 0.0130 | 0.025 | 700.3 | 1.9 | 236 |
| 13 | 800.0 | 440.00 | 7.80 | 0.55 | 0.0097 | 0.019 | 697.6 | 2.3 | 236 |
| 14 | 800.0 | 440.00 | 5.20 | 0.55 | 0.0065 | 0.012 | 706.5 | 1.1 | 236 |
| 15 | 800.0 | 440.00 | 20.79 | 0.55 | 0.0260 | 0.05 | 694.0 | 2.6 | 236 |
| 16 | 800.0 | 440.00 | 10.40 | 0.55 | 0.0130 | 0.025 | 695.1 | 2.6 | 236 |
| | | | IKA | | | | | | |
| 17 | 800.0 | 440.00 | 20.79 | 0.55 | 0.0260 | 0.05 | 708.1 | 0.6 | 150 |
| 18 | 800.0 | 440.00 | 10.40 | 0.55 | 0.0130 | 0.025 | 711.9 | 0.2 | 150 |
| 19 | 800.0 | 440.00 | 7.80 | 0.55 | 0.0097 | 0.019 | 709.1 | 0.7 | 150 |
| 20 | 800.0 | 440.00 | 5.20 | 0.55 | 0.0065 | 0.012 | 712.1 | 0.3 | 150 |

C.G. = Coffee Grounds

For samples 5-20, all spent coffee grounds materials were incorporated dry powders, except for samples 15 and 16 which were pre-soaked in water for 25 hours prior to incorporation. No defoamers were incorporated into the cementitious compositions used in these tests.

The spent coffee grounds used in Samples 5 and 6 were comminuted by pulverizing using a Retsch RS200 Ring Milling Machine. The spent coffee grounds used in Samples 7-10 were comminuted in a Munson Centrifugal Impact Mill (pin mill), achieving particle sizes averaging about 417 μm as measured by a Malvern Instruments Mastersizer 2000 unit, with 80% of the particles having a particle size between 87 and 947 μm, and a surface weighted mean of about 201 μm and a volume weighted mean of 473 μm.

The spent coffee grounds used in Samples 11-16 were comminuted in a lab scale Waring blender, achieving particle sizes averaging about 181 μm as measured by a Malvern Instruments Mastersizer 2000 unit, with 80% of the particles having a particle size between 63 and 497 μm, and a surface weighted mean of about 125 μm and a volume weighted mean of 236 μm.

The spent coffee grounds used in Samples 17-20 were comminuted in an IKA high shear mixer, achieving particle sizes averaging about 77 μm as measured by a Malvern Instruments Mastersizer 2000 unit, with 80% of the particles having a particle size between 10 and 413 μm, and a surface weighted mean of about 19 μm and a volume weighted mean of 150 μm.

The cementitious paste Samples 5-20 were tested according to the BASF micro-strain freeze-thaw test method set forth above. As shown in FIG. 6, specimens of Sample 5 containing a loading of 1% by volume comminuted spent coffee grounds, and Sample 6, containing a loading of 2% by volume comminuted spent coffee grounds, both exhibited freeze-thaw damage resistance for multiple cycles of freezing and thawing. Duplicate specimens of both samples, exhibited linear contraction to about negative 5° C. when subjected to the cooling cycle, as did specimens of Samples 3 and 4 shown in FIGS. 2 and 3. Below negative 5° C., the micro-strain sensors indicate that the Samples 5 and 6 specimens continued to contract substantially linearly, following substantially the same reverse rate of expansion during the warming cycle. The comminuted spent coffee grounds-containing specimens of Samples 5 and 6 exhibited similar contraction characteristics in subsequent freeze-thaw cycles.

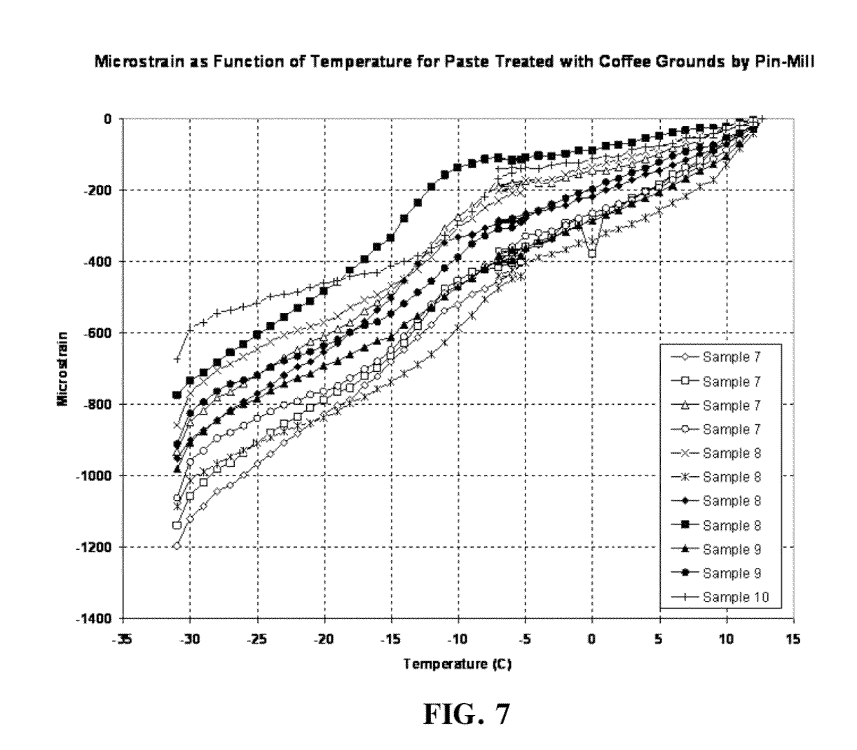

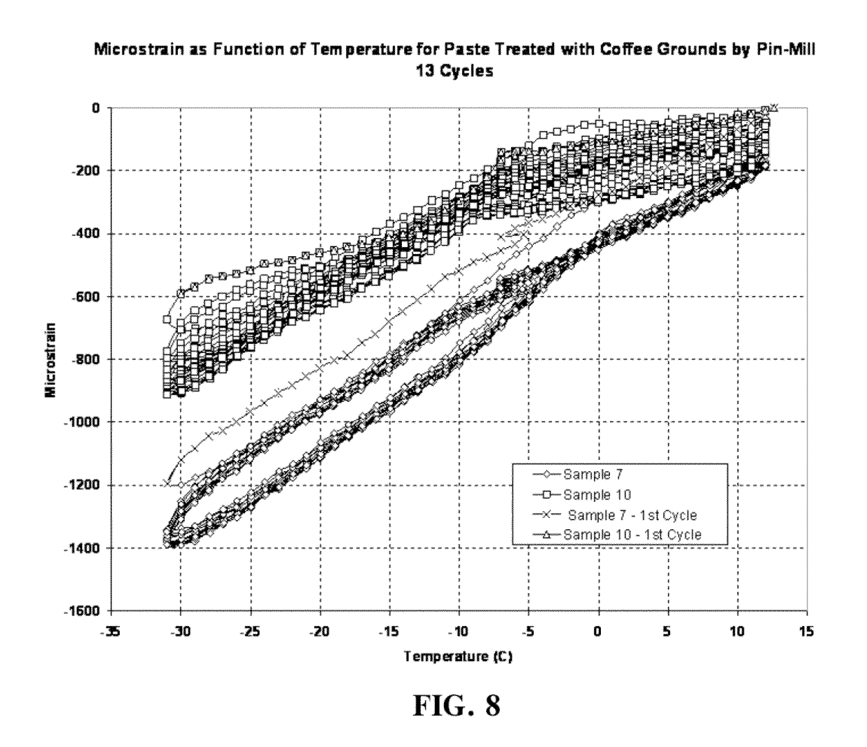

As shown in FIG. 7, specimens of Samples 7 to 10 containing loadings of from 1.2 percent to 5 percent by volume spent coffee grounds comminuted in the commercial pin mill, all exhibited the characteristic freeze-thaw damage resistant substantially linear contraction during cooling both above and below negative 5° C. As shown in FIG. 8, specimens of Samples 7 and 10, at loadings of 5% and 1.2% by volume respectively, were tested for multiple freeze-thaw cycles. The micro-strain sensors indicated that the specimens exhibited substantially linear contraction during cooling, both above and below negative 5° C., following substantially the same reverse rates of expansion during the warming cycle.

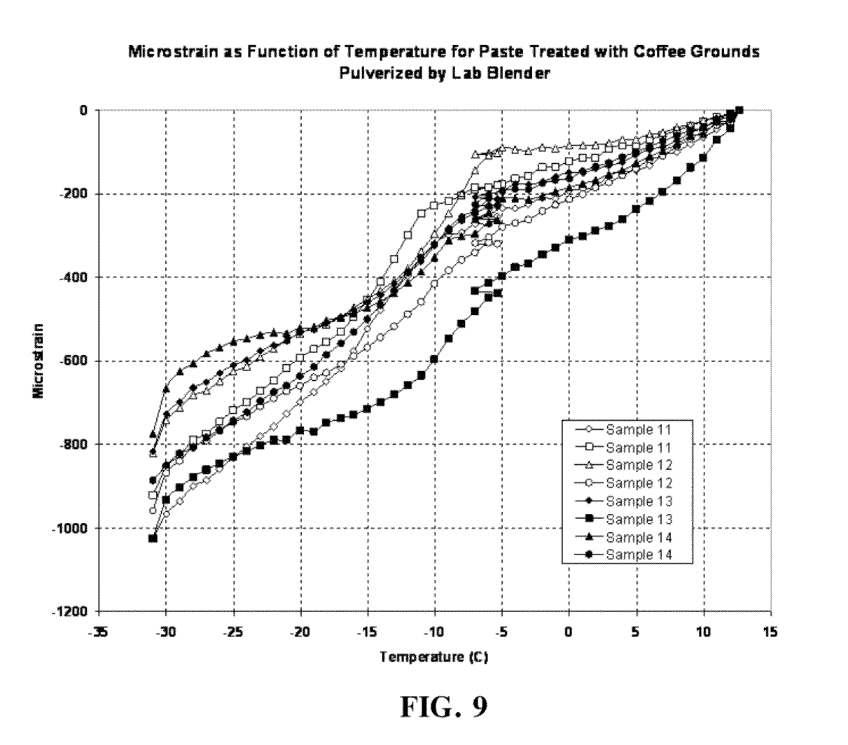

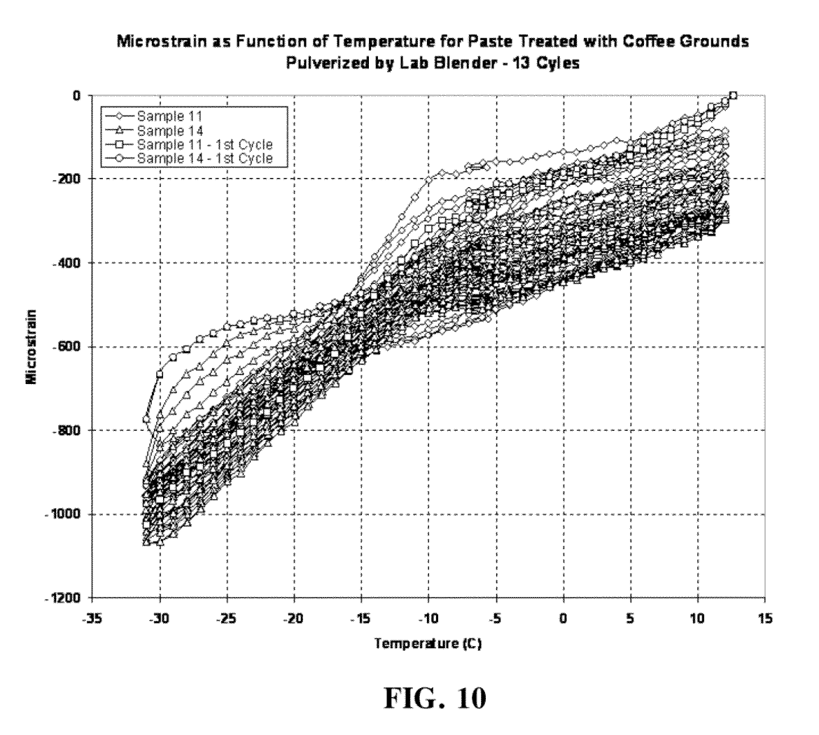

As shown in FIG. 9, specimens of Samples 11 to 14 containing loadings of from 1.2 percent to 5 percent by volume spent coffee grounds comminuted in the laboratory blender, all exhibited the characteristic freeze-thaw damage resistant substantially linear contraction during cooling, both above and below negative 5° C. As shown in FIG. 10, specimens of Samples 11 and 14, at loadings of 5% and 1.2% by volume respectively, were tested for multiple freeze-thaw cycles. The micro-strain sensors indicated that the specimens exhibited substantially linear contraction during cooling, both above and below negative 5° C., following substantially the same reverse rates of expansion during the warming cycle.

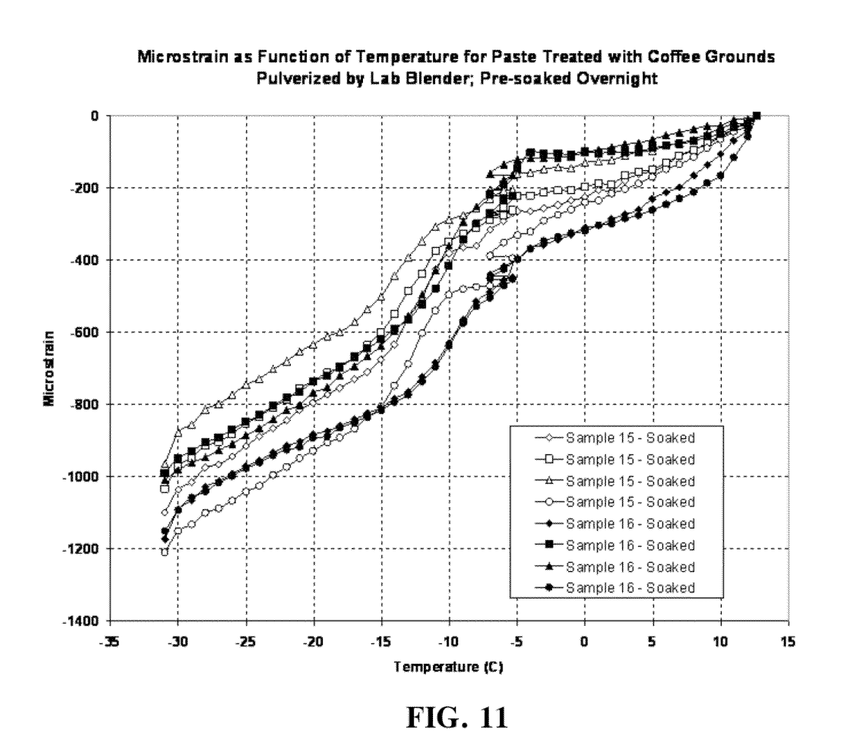

As shown in FIG. 11, multiple specimens of Samples 15 and 16, containing loadings of 5% and 2.5% by volume respectively of pre-soaked spent coffee grounds comminuted in the laboratory blender, all exhibited the characteristic freeze-thaw damage resistant substantially linear contraction during cooling, both above and below negative 5° C.

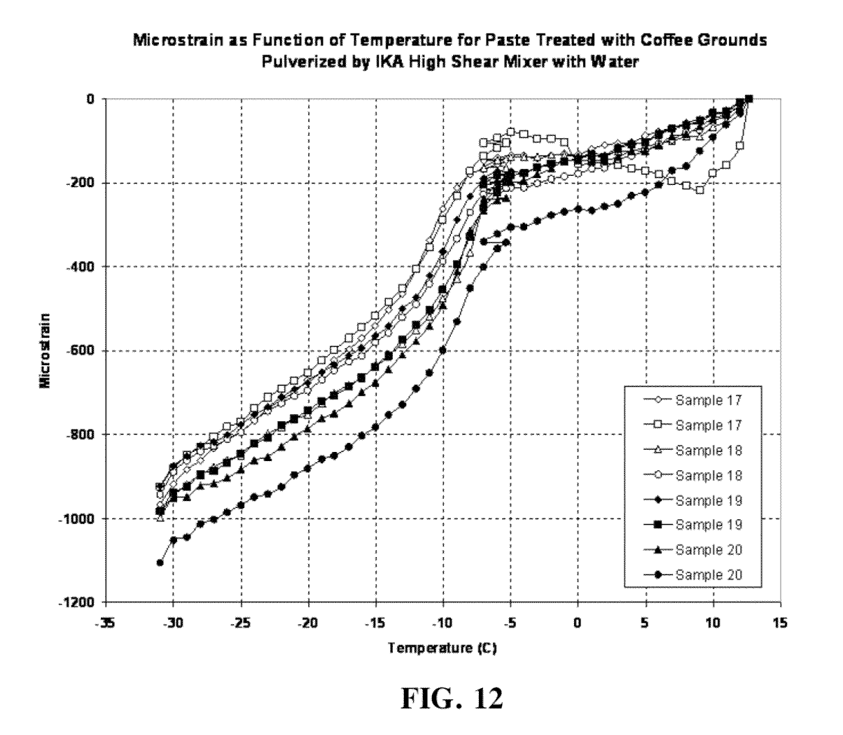

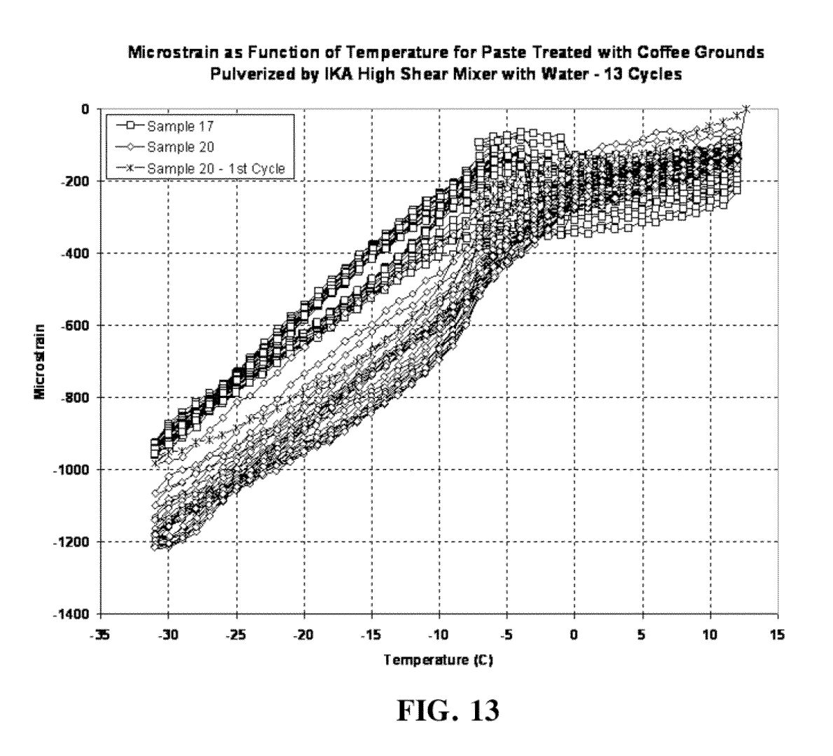

As shown in FIG. 12, specimens of Samples 17 to 20 containing loadings of from 1.2 percent to 5 percent by volume spent coffee grounds comminuted in the high shear mixer, exhibited the characteristic freeze-thaw damage resistant substantially linear contraction during cooling, both above and below negative 5° C. As shown in FIG. 13, specimens of Samples 17 and 20, at loadings of 5% and 1.2% by volume respectively, were tested for multiple freeze-thaw cycles. The micro-strain sensors indicated that the specimens exhibited substantially linear contraction during cooling, both above and below negative 5° C., following substantially the same reverse rates of expansion during the warming cycle.

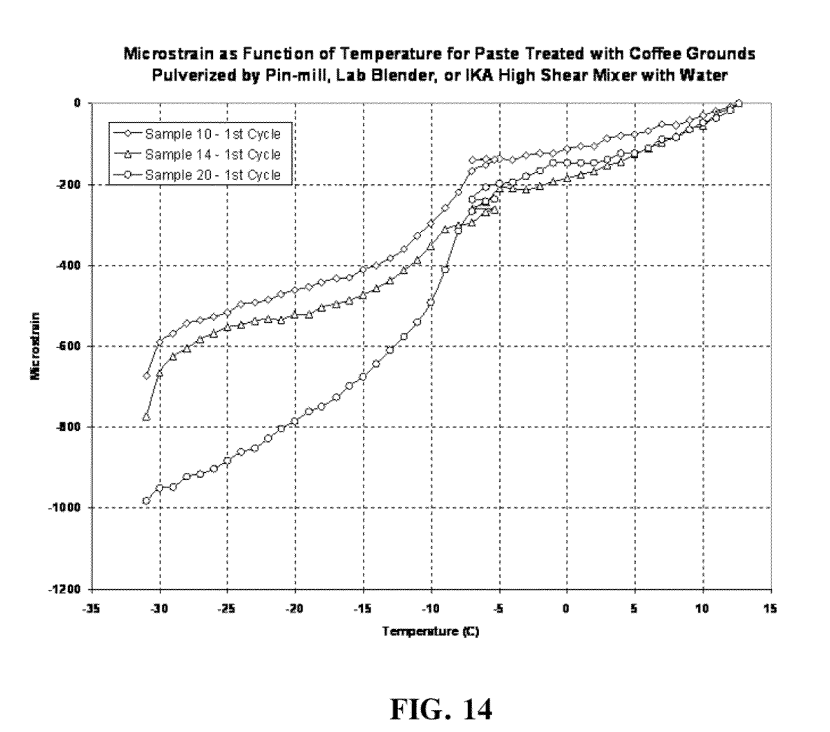

Specimens of Samples 10, 14 and 20, each containing a 1.2% by volume loading of spent coffee grounds but comminuted by different methods and having different particle sizes as discussed above, were tested for freeze-thaw damage resistance. As shown in FIG. 14, each specimen exhibited the characteristic freeze-thaw damage resistant substantially linear contraction during cooling, both above and below negative 5° C.

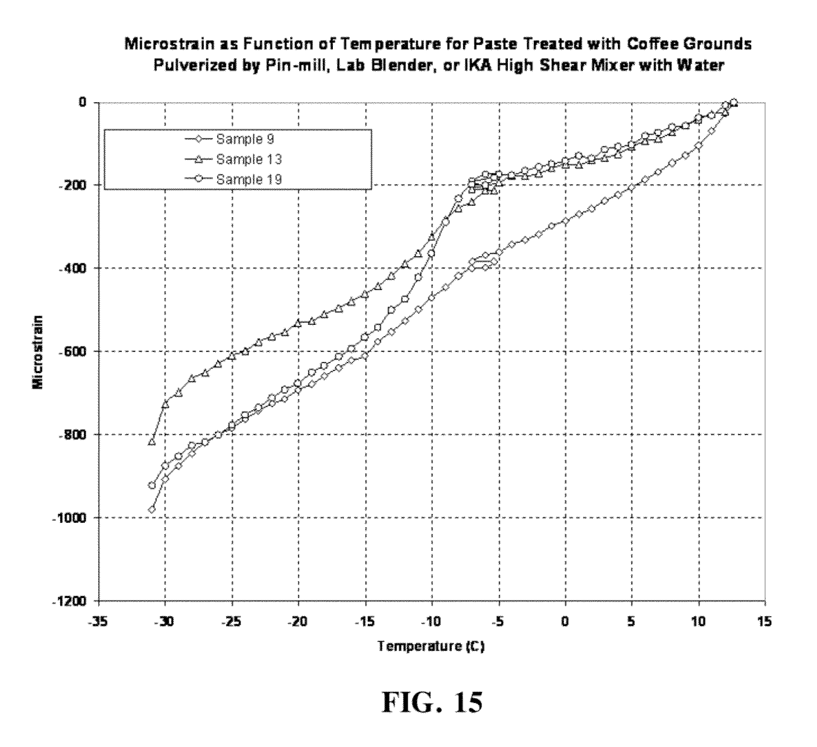

Specimens of Samples 9, 13 and 19, each containing a 1.9% by volume loading of spent coffee grounds but comminuted by different methods and having different particle sizes as discussed above, were tested for freeze-thaw damage resistance. As shown in FIG. 15, each specimen exhibited the characteristic freeze-thaw damage resistant substantially linear contraction during cooling, both above and below negative 5° C.

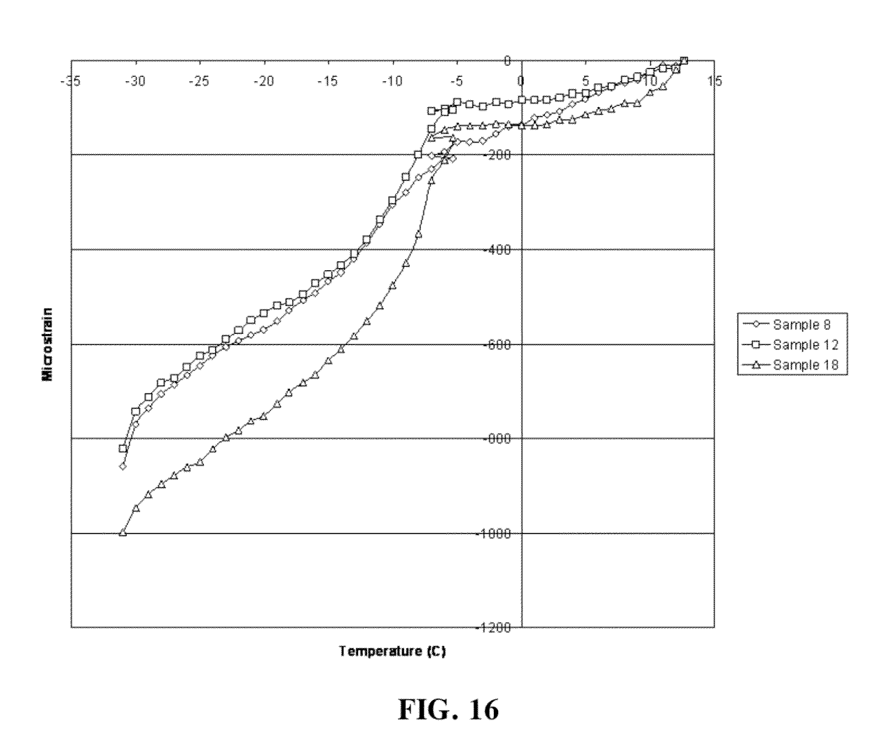

Specimens of Samples 8, 12 and 18, each containing a 2.5% by volume loading of spent coffee grounds but comminuted by different methods and having different particle sizes and discussed above, were tested for freeze-thaw damage resistance. As shown in FIG. 16, each specimen exhibited the characteristic freeze-thaw damage resistant substantially linear contraction during cooling, both above and below negative 5° C.

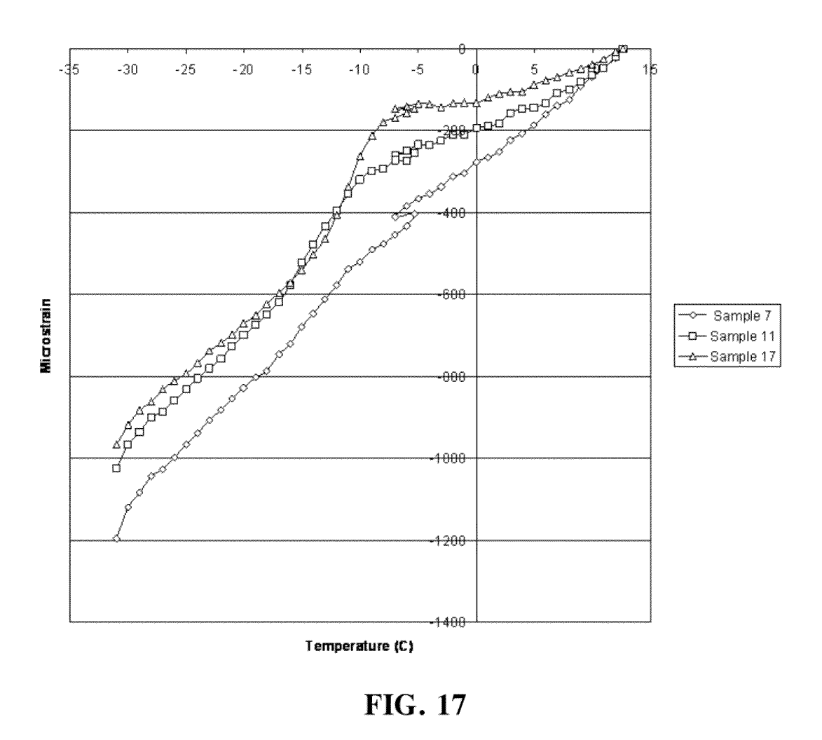

Specimens of Samples 7, 11 and 17, each containing a 5% by volume loading of spent coffee grounds but comminuted by different methods and having different particle sizes as discussed above, were tested for freeze-thaw damage resistance. As shown in FIG. 17, each specimen exhibited the characteristic freeze-thaw damage resistant substantially linear contraction during cooling, both above and below negative 5° C.

The specimens of Samples 5-20 each exhibited freeze-thaw durability according to the BASF freeze-thaw test method. The freeze-thaw durability of these cementitious composition samples is attributed to the presence of the comminuted spent coffee grounds in the cementitious compositions. As shown in Table 4, none of Samples 5-20 contained a percentage of entrained air sufficient to result in freeze-thaw durability in and of itself; none having higher than 2.6% entrained air.

Further specimens were tested in order to determine the efficacy of various sizes of comminuted spent coffee grounds particles on the freeze-thaw damage resistance of cementitious compositions. These specimens were tested according to ASTM C666. ASTM C666 provides two procedures for conducting tests to determine the resistance of concrete specimens to rapid freezing and thawing in water, and to rapid freezing in air and thawing in water. The concrete specimens for the ASTM C666 test are generally on the order of 3″×4″×16″ (7.62 cm×10.16 cm×40.64 cm), and specifically are not less than 3 inches (7.62 cm) or more than 5 inches (12.7 cm) in width or height or diameter and not less than 11 inches (27.94 cm) or more than 16 inches (40.64 cm) in length. The relative dynamic modulus of each specimen is measured initially at −2° F. (−18.8° C.) to +4° F. (15.5° C.) of the target freeze-thaw temperature and to the tolerances required in ASTM C 215, and the relative dynamic modulus test is repeated periodically during the freeze-thaw cycling, with specimens being removed from the freeze-thaw apparatus at intervals not exceeding 36 cycles.

A nominal cycle consists of lowering the temperature of the specimens from 40° F. to 0° F. (+4.4° C. to −17.8° C.) and then raising the temperature from 0° F. to 40° F. (−17.8° C. to +4.4° C.) in not less than 2 or more than 5 hours. The period of transition between freezing and thawing cycles is not more than 10 minutes.

These procedures require that the test be continued until the specimens have sustained 300 cycles of freezing and thawing (approximately 25 to 60 days) or until the dynamic modulus (D.M.) of elasticity has reached 60% of initial modulus. A measure of the durability, the durability factor DF, may then be calculated from the equation:

$$DF = \frac{PN}{M}$$

where
P=relative dynamic modulus of elasticity at N cycles (%),
N=number of cycles at which P reaches the specified minimum value for discontinuing the test or the specified number of cycles at which the exposure is to be terminated, whichever is less, and
M=specified number of cycles at which the exposure is to be terminated.
   The standard states that the methods are not intended to provide a quantitative measure of the length of service that may be expected from a specific type of concrete under field conditions.

The result of the ASTM C666 test is a single data point, pass or fail. Because of the standard deviation of individual specimens, it is necessary to conduct the tests on sets of specimens.

These experiments show that, while many different sizes of coffee grounds particles provide improved freeze-thaw damage resistance to cementitious compositions, the improvement in freeze-thaw damage resistance may be at least in part a function of the average particle size of the coffee grounds particles. Samples 21-36 are shown in Tables 5-8. Samples 21-24 (Table 5) contained coffee grounds particles with an average diameter of 400 μm. Samples 25-28 (Table 6) contained coffee grounds particles with an average diameter of 200 μm. Samples 29-32 (Table 7) contained coffee grounds particles with an average diameter of 150 μm. Samples 33-36 (Table 8) contained coffee grounds particles with an average diameter of 100 μm.

TABLE 5

| | Sample No. | | | |
|---|---|---|---|---|
| | 21 | 22 | 23 | 24 |
| Cement (lb) | 17.2 | 17.2 | 17.2 | 17.2 |
| Sand (lb) | 46.0 | 46.0 | 46.0 | 46.0 |
| Stone (lb) | 62.7 | 62.7 | 62.7 | 62.7 |
| Water (lb) | 9.5 | 9.5 | 9.5 | 9.5 |
| Sand:Aggregate | 0.44 | 0.44 | 0.44 | 0.44 |
| Water:Cement | 0.55 | 0.55 | 0.55 | 0.55 |
| TBP (ml) | 17.0 | 17.0 | 17.0 | 17.0 |
| Water reducer (ml) | 40.0 | 40.0 | 40.0 | 60.0 |
| C.G.-400 μm (g) | 183 | 219 | 293 | 439 |
| C.G.-weight % | 2.35 | 2.81 | 3.76 | 5.63 |
| C.G.-volume % | 1.25 | 1.5 | 2.0 | 3.0 |
| Air (%) | 1.8 | 2.2 | 2.6 | 2.8 |
| Slump (in) | 7.5 | 7.5 | 2.5 | 2.5 |
| # Cycles* | 108 | 108 | 108 | 108 |
| D.M. (%) | 57 | 48 | 62 | 88 |

TBP = Tributyl Phosphate (Defoamer)
C.G. = Comminuted Coffee Grounds
*The apparatus experienced a malfunction after 108 cycles.

TABLE 6

| | Sample No. | | | |
|---|---|---|---|---|
| | 25 | 26 | 27 | 28 |
| Cement (lb) | 17.2 | 17.2 | 17.2 | 17.2 |
| Sand (lb) | 46.0 | 46.0 | 46.0 | 46.0 |
| Stone (lb) | 62.7 | 62.7 | 62.7 | 62.7 |
| Water (lb) | 9.5 | 9.5 | 9.5 | 9.5 |
| Sand:Aggregate | 0.44 | 0.44 | 0.44 | 0.44 |
| Water:Cement | 0.55 | 0.55 | 0.55 | 0.55 |
| TBP (ml) | 17.0 | 17.0 | 17.0 | 17.0 |
| Water reducer (ml) | 60.0 | 60.0 | 60.0 | 100.0 |
| C.G.-200 μm (g) | 183 | 219 | 293 | 439 |
| C.G.-weight % | 2.35 | 2.81 | 3.76 | 5.63 |
| C.G.-volume % | 1.25 | 1.5 | 2.0 | 3.0 |
| Air (%) | 2.1 | 2.3 | 3.0 | 2.3 |
| Slump (in) | 7.75 | 5.5 | 2.75 | 1.25 |
| # Cycles* | 108 | 108 | 108 | 108 |
| D.M. (%) | Failed | 76 | Failed | Failed |

TBP = Tributyl Phosphate (Defoamer)
C.G. = Comminuted Coffee Grounds
*The apparatus experienced a malfunction after 108 cycles.

TABLE 7

| | Sample No. | | | |
|---|---|---|---|---|
| | 29 | 30 | 31 | 32 |
| Cement (lb) | 17.2 | 17.2 | 17.2 | 17.2 |
| Sand (lb) | 46.0 | 46.0 | 46.0 | 46.0 |
| Stone (lb) | 62.7 | 62.7 | 62.7 | 62.7 |
| Water (lb) | 9.5 | 9.5 | 9.5 | 9.5 |
| Sand:Aggregate | 0.44 | 0.44 | 0.44 | 0.44 |
| Water:Cement | 0.55 | 0.55 | 0.55 | 0.55 |
| TBP (ml) | 17.0 | 17.0 | 17.0 | 17.0 |
| Water reducer (ml) | 110.0 | 80.0 | 80.0 | 80.0 |
| C.G.-150 μm (g) | 183 | 219 | 293 | 439 |
| C.G.-weight % | 2.35 | 2.81 | 3.76 | 5.63 |
| C.G.-volume % | 1.25 | 1.5 | 2.0 | 3.0 |
| Air (%) | 1.2 | 1.2 | 1.8 | 2.0 |
| Slump (in) | 9.5 | 8.0 | 8.0 | 8.0 |
| # Cycles | 36 | 36 | 36 | 36 |
| D.M. (%) | Failed | 76 | 89 | 91 |

TBP = Tributyl Phosphate (Defoamer)
C.G. = Comminuted Coffee Grounds

TABLE 8

| | Sample No. | | | |
|---|---|---|---|---|
| | 33 | 34 | 35 | 36 |
| Cement (lb) | 17.2 | 17.2 | 17.2 | 17.2 |
| Sand (lb) | 46.0 | 46.0 | 46.0 | 46.0 |
| Stone (lb) | 62.7 | 62.7 | 62.7 | 62.7 |
| Water (lb) | 9.5 | 9.5 | 9.5 | 9.5 |
| Sand:Aggregate | 0.44 | 0.44 | 0.44 | 0.44 |
| Water:Cement | 0.55 | 0.55 | 0.55 | 0.55 |
| TBP (ml) | 17.0 | 17.0 | 17.0 | 17.0 |
| Water reducer (ml) | 130.0 | 130.0 | 130.0 | 130.0 |
| C.G.-100 μm (g) | 183 | 219 | 293 | 439 |
| C.G.-weight % | 2.35 | 2.81 | 3.76 | 5.63 |
| C.G.-volume % | 1.25 | 1.5 | 2.0 | 3.0 |
| Air (%) | 1.6 | 1.8 | 2.1 | 2.2 |
| Slump (in) | 8.5 | 8.25 | 5.25 | 0.5 |
| # Cycles | 36 | 36 | 36 | 36 |
| D.M. (%) | 73 | 93 | 80 | 78 |

TBP = Tributyl Phosphate (Defoamer)
C.G. = Comminuted Coffee Grounds

The above microstrain and ASTM experimentation shows that coffee grounds particles provide enhanced freeze-thaw damage resistance to cementitious compositions. With respect to the problem discussed above in which air entraining admixture surfactant tends to adsorb to the fly ash surfaces, this problem can be avoided through the use of coffee grounds particles of up to 1000 to 2000 μm volume-weighted mean diameter, since the coffee grounds particles would be too large to adsorb to fly ash surfaces.

The cementitious compositions of Samples 37 through 46 were created similarly to Samples 5-20, except that Sample 37 through 46 contained various amounts of starch microcontainers (“SMC”) instead of comminuted spent coffee grounds. Specifically, Samples 37 through 46 included the following amounts of starch microcontainers, by volume, and the following pore characteristics (“Pore Char.”), as shown in Table 9.

TABLE 9

| Sample | | |
|---|---|---|
| No. | % SMC by vol. | Pore Char. (ml/g) |
| 37A | 4 | 0.23 |
| 37B | 4 | 0.23 |
| 38A | 2 | 0.23 |
| 38B | 2 | 0.23 |
| 39A | 1 | 0.23 |
| 39B | 1 | 0.23 |
| 40A | 0.75 | 0.23 |
| 40B | 0.75 | 0.23 |
| 41A | 0.5 | 0.23 |
| 41B | 0.5 | 0.23 |
| 42 | 4 | 0.59 |
| 43A | 2 | 0.59 |
| 43B | 2 | 0.59 |
| 44A | 1 | 0.59 |
| 44B | 1 | 0.59 |
| 45A | 0.75 | 0.59 |
| 45B | 0.75 | 0.59 |
| 46A | 0.5 | 0.59 |
| 46B | 0.5 | 0.59 |

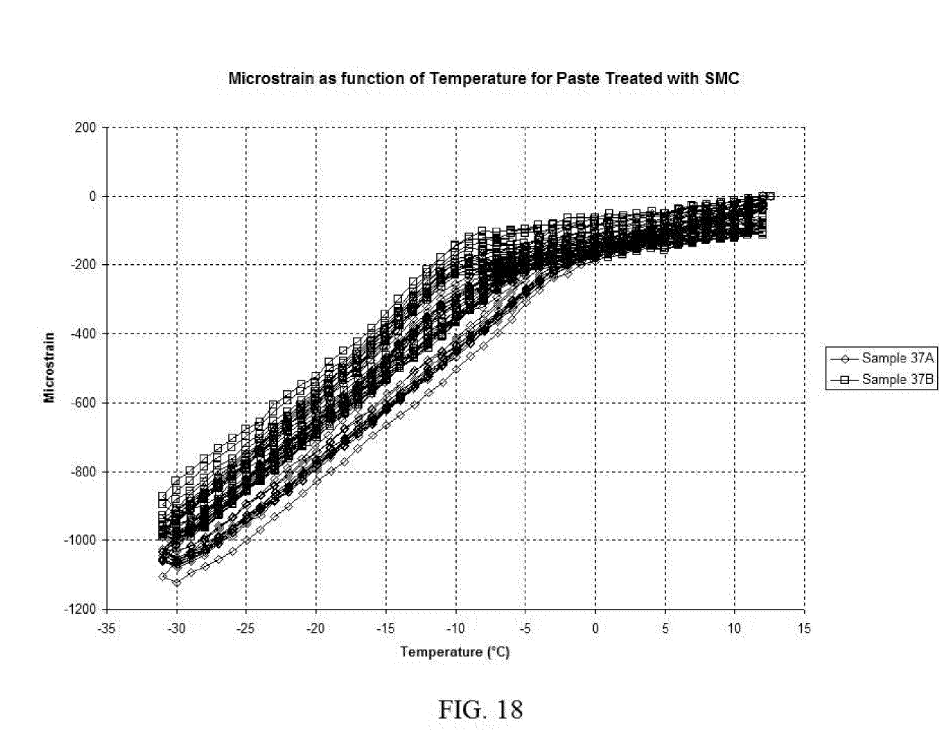

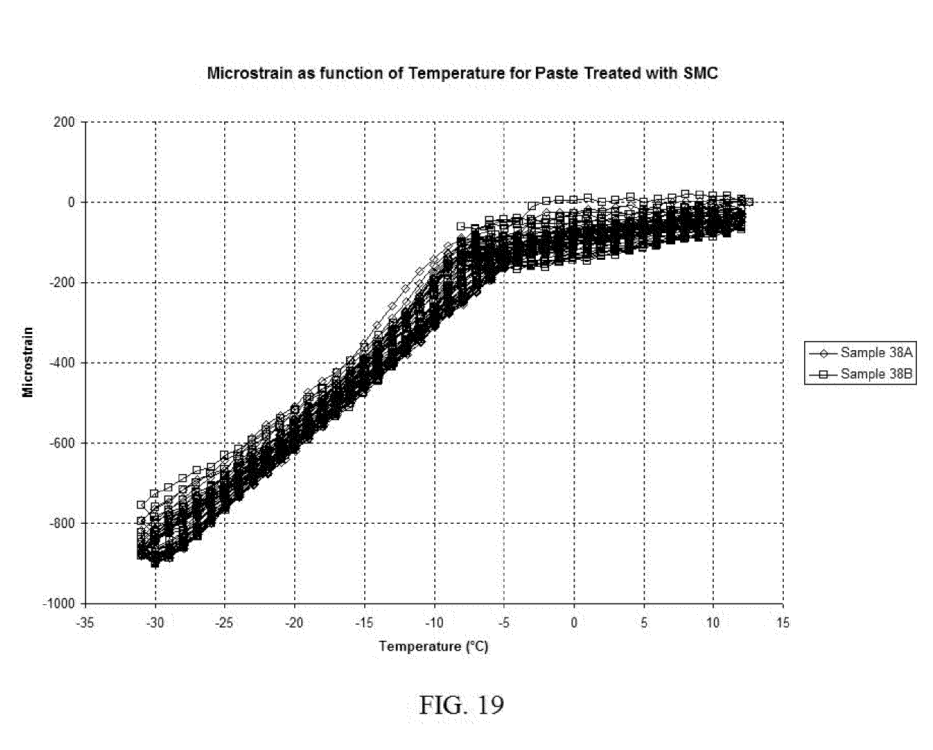

As shown in FIGS. 18 and 19, specimens of Samples 37A, 37B, 38A and 38B were tested for multiple freeze-thaw cycles. The micro-strain sensors indicated that the specimens exhibited substantially linear contraction during cooling, both above and below negative 5° C., following substantially the same reverse rates of expansion during the warming cycle.

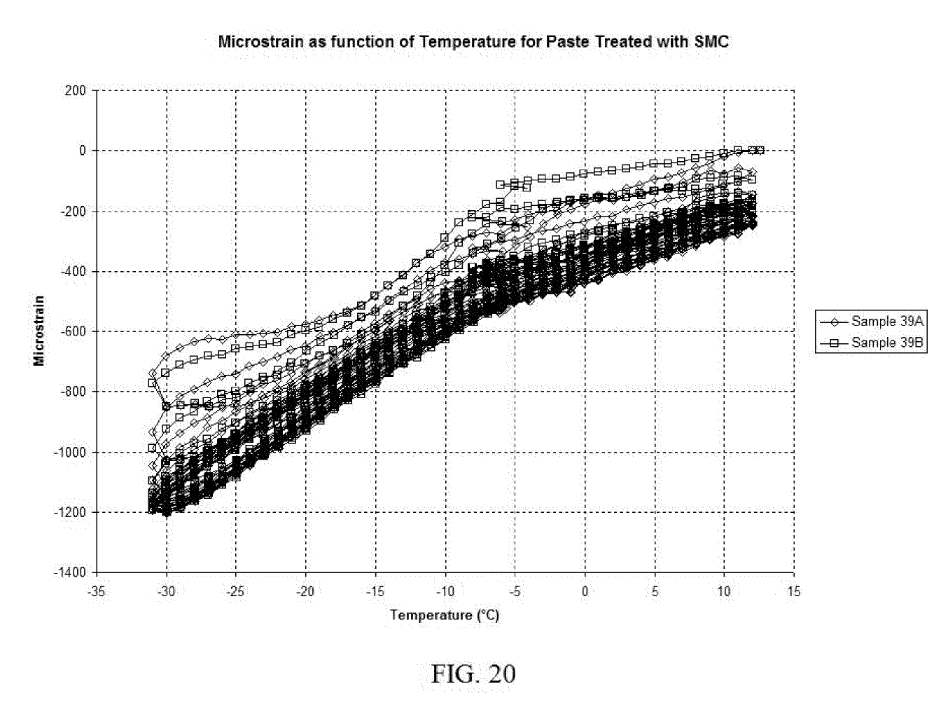

As shown in FIGS. 20-22, specimens of Samples 39A, 39B, 40A, 40B, 41A and 41B were tested for multiple freeze-thaw cycles. The micro-strain sensors indicated that the specimens exhibited substantially linear contraction during cooling above negative 5° C., with non-linear contraction during cooling below negative 5° C.

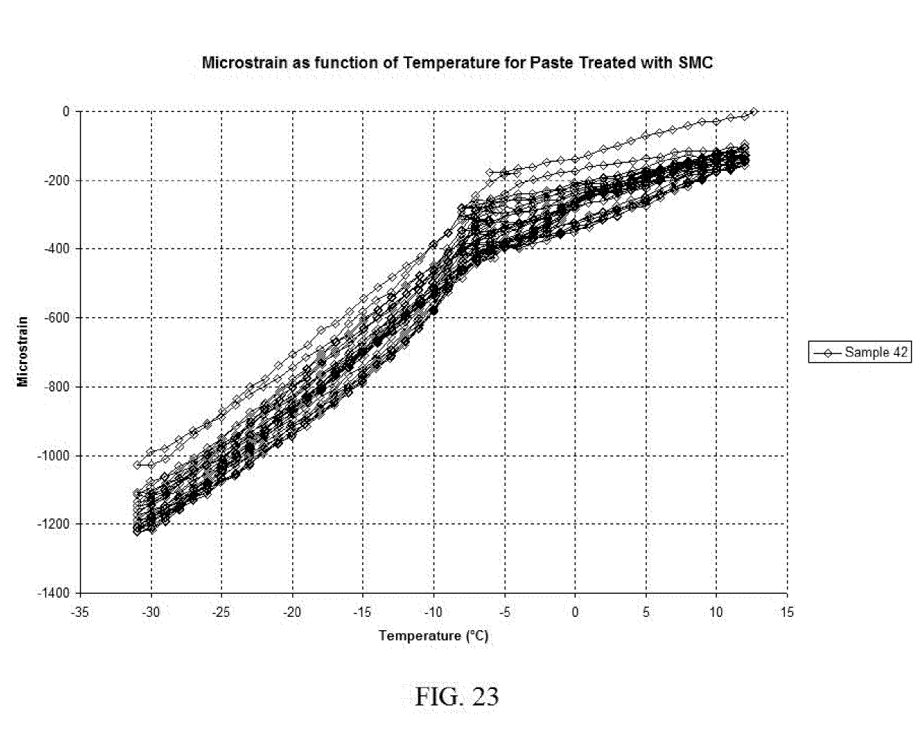

As shown in FIGS. 23-25 specimens of Samples 42, 43A, 43B, 44A and 44B were tested for multiple freeze-thaw cycles. The micro-strain sensors indicated that the specimens exhibited substantially linear contraction during cooling, both above and below negative 5° C., following substantially the same reverse rates of expansion during the warming cycle. It appears as though there was an error in the microstrain sensors during one of the cycles experienced by sample 43B, which resulted in atypical data during that cycle.

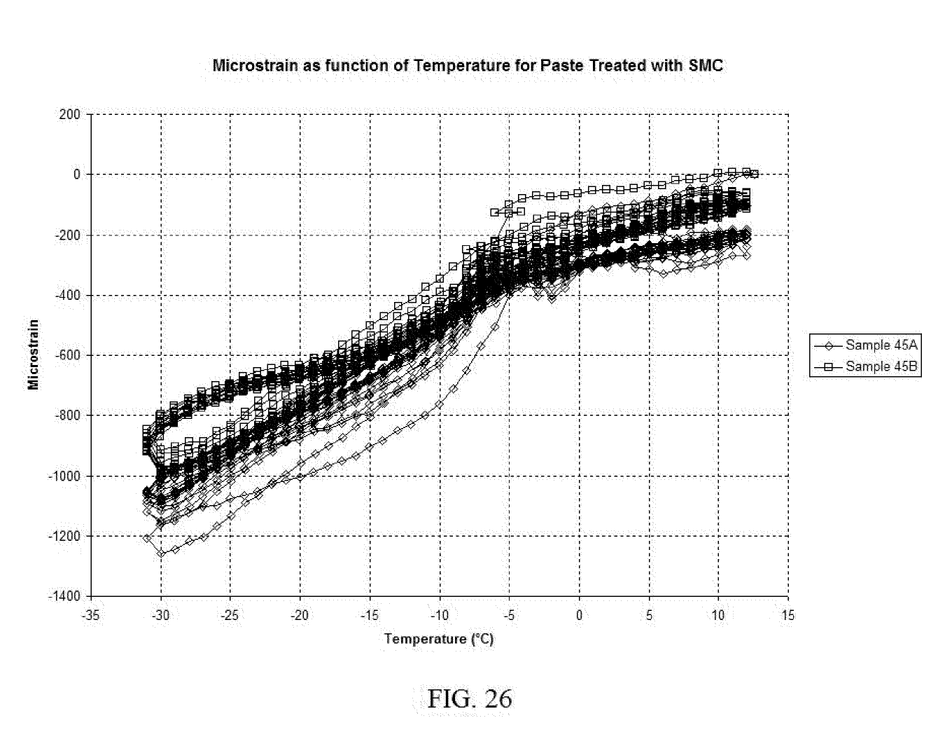

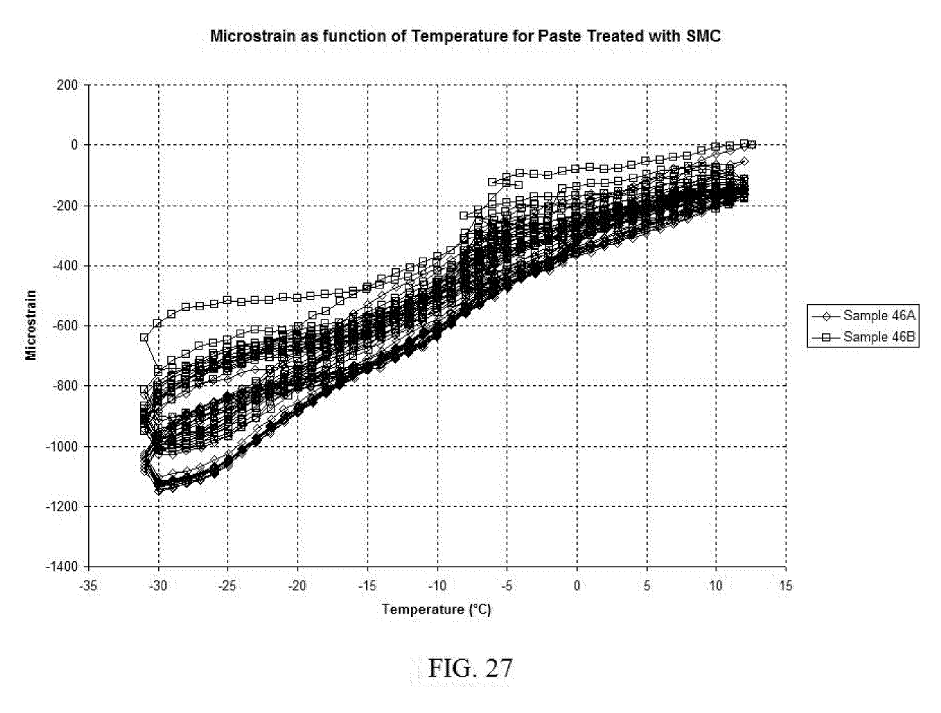

As shown in FIGS. 26 and 27, specimens of Samples 45A, 45B, 46A and 46B were tested for multiple freeze-thaw cycles. The micro-strain sensors indicated that the specimens exhibited substantially linear contraction during cooling above negative 5° C., with somewhat non-linear contraction during cooling below negative 5° C.

In a first embodiment, a subject cementitious freeze-thaw damage resistant composition may comprise hydraulic cement, and coffee grounds particles having a volume-weighted mean particle size of from greater than 50 μm to about 2000 μm.

The cementitious composition of the first embodiment may further include that the coffee grounds particles have a volume-weighted mean diameter of from greater than 50 μm to about 1000 μm.

The cementitious composition of either or both of the first or subsequent embodiments may further include that the coffee grounds particles are present in a range from about 0.2% to about 7% of total volume.

The cementitious composition of any of the first or subsequent embodiments may further include that the coffee grounds particles are present in a range from about 0.25% to about 3% of total volume.

The cementitious composition of any of the first or subsequent embodiments may further include that the coffee grounds particles are present in a range from about 0.5% to about 12% by weight of dry cement.

The cementitious composition of any of the first or subsequent embodiments may further include that the coffee grounds particles are present in a range from about 0.65% to about 5.6% by weight of dry cement.

The cementitious composition of any of the first or subsequent embodiments may further include that the coffee grounds particles comprise comminuted spent coffee grounds.

The cementitious composition of any of the first or subsequent embodiments may further comprise independently at least one of air entrainers, aggregates, pozzolans, dispersants, set and strength accelerators/enhancers, set retarders, water reducers, corrosion inhibitors, wetting agents, water soluble polymers, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures, or mixtures thereof. The cementitious composition may further include that the dispersant is at least one of lignosulfonates, beta naphthalene sulfonates, sulfonated melamine formaldehyde condensates, polyaspartates, naphthalene sulfonate formaldehyde condensate resins, oligomerics, polycarboxylates, or mixtures thereof.

In a second embodiment, a subject method for preparing a freeze-thaw damage resistant cementitious composition may comprise forming a mixture of water, hydraulic cement, and coffee grounds particles having a volume-weighted mean particle size of from greater than 50 μm to about 2000 μm.

The method of the second embodiment may further include that the coffee grounds particles are added to the mixture in at least one of the following forms: a. compact mass; b. powder; or c. liquid admixture. The liquid admixture may be at least one of a viscosity modifying admixture, paste or slurry.

The method of either or both of the second or subsequent embodiments may further include that the coffee grounds particles are present in a range from about 0.2% to about 7% of total volume.

The method of any of the second or subsequent embodiments may further include that the coffee grounds particles are present in a range from about 0.25% to about 3% of total volume.

The method of any of the second or subsequent embodiments may further include that the coffee grounds particles are present in a range from about 0.5% to about 12% by weight of dry cement.

The method of any of the second or subsequent embodiments may further include that the coffee grounds particles are present in a range from about 0.65% to about 5.6% by weight of dry cement.

The method of any of the second or subsequent embodiments may further include that the coffee grounds particles comprise comminuted spent coffee grounds.

In a third embodiment, a subject cementitious freeze-thaw damage resistant composition may comprise hydraulic cement, and organic particles comprising at least one of coffee grounds particles, leaf powder particles, starch microcontainers, ground tea leaf particles, or cork powder particles.

The cementitious composition of the first embodiment may further include that the organic particles are present in a range from about 0.2% to about 7% of total volume.

The cementitious composition of either or both of the first or subsequent embodiments may further include that the organic particles are present in a range from about 0.25% to about 3% of total volume.

The cementitious composition of any of the first or subsequent embodiments may further include, independently, at least one of air entrainers, aggregates, pozzolans, dispersants, set and strength accelerators/enhancers, set retarders, water reducers, corrosion inhibitors, wetting agents, water soluble polymers, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures, or mixtures thereof. The dispersant may be at least one of lignosulfonates, beta naphthalene sulfonates, sulfonated melamine formaldehyde condensates, polyaspartates, naphthalene sulfonate formaldehyde condensate resins, oligomerics, polycarboxylates, or mixtures thereof.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

We claim:

1. A cementitious freeze-thaw damage resistant composition comprising hydraulic cement, and coffee grounds particles having a volume-weighted mean particle size of from greater than 50 μm to about 2000 μm.

2. The cementitious composition of claim 1 wherein the coffee grounds particles have a volume-weighted mean diameter of from greater than 50 μm to about 1000 μm.

3. The cementitious composition of claim 1 wherein the coffee grounds particles are present in a range from about 0.2% to about 7% of total volume.

4. The cementitious composition of claim 1 wherein the coffee grounds particles are present in a range from about 0.25% to about 3% of total volume.

5. The cementitious composition of claim 1 wherein the coffee grounds particles comprise comminuted spent coffee grounds.

6. The cementitious composition of claim 1 further comprising independently at least one of air entrainers, aggregates, pozzolans, dispersants, set and strength accelerators/enhancers, set retarders, water reducers, corrosion inhibitors, wetting agents, water soluble polymers, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures, or mixtures thereof.

7. The cementitious composition of claim 6 wherein the dispersant is at least one of lignosulfonates, beta naphthalene sulfonates, sulfonated melamine formaldehyde condensates, polyaspartates, naphthalene sulfonate formaldehyde condensate resins, oligomerics, polycarboxylates, or mixtures thereof.

8. A method for preparing a freeze-thaw damage resistant cementitious composition comprising forming a mixture of water, hydraulic cement, and coffee grounds particles having a volume-weighted mean particle size of from greater than 50 μm to about 2000 μm.

9. The method of claim 8, wherein the coffee grounds particles are added to the mixture in at least one of the following forms:
a. compact mass;
b. powder; or
c. liquid admixture.

10. The method of claim 9, wherein the liquid admixture is at least one of a viscosity modifying admixture, paste or slurry.

11. The method of claim 8 wherein the coffee grounds particles are present in a range from about 0.2% to about 7% of total volume.

12. The method of claim 8 wherein the coffee grounds particles are present in a range from about 0.25% to about 3% of total volume.

13. The method of claim 8 wherein the coffee grounds particles comprise comminuted spent coffee grounds.

14. A cementitious freeze-thaw damage resistant composition comprising hydraulic cement, and organic particles comprising at least one of coffee grounds particles, leaf powder particles, starch microcontainers, ground tea leaf particles, or cork powder particles.

15. The cementitious composition of claim 1 wherein the organic particles are present in a range from about 0.2% to about 7% of total volume.

16. The cementitious composition of claim 1 wherein the organic particles are present in a range from about 0.25% to about 3% of total volume.

17. The cementitious composition of claim 14 further comprising independently at least one of air entrainers, aggregates, pozzolans, dispersants, set and strength accelerators/enhancers, set retarders, water reducers, corrosion inhibitors, wetting agents, water soluble polymers, water repellents, fibers, dampproofing admixtures, permeability reducers, pumping aids, fungicidal admixtures, germicidal admixtures, insecticide admixtures, finely divided mineral admixtures, coloring admixtures, alkali-reactivity reducer, bonding admixtures, shrinkage reducing admixtures, or mixtures thereof.

18. The cementitious composition of claim 17 wherein the dispersant is at least one of lignosulfonates, beta naphthalene sulfonates, sulfonated melamine formaldehyde condensates, polyaspartates, naphthalene sulfonate formaldehyde condensate resins, oligomerics, polycarboxylates, or mixtures thereof.
